(19) United States
(12) Patent Application Publication
(10) Pub. No.: US 2013/0024262 A1
(43) Pub. Date: Jan. 24, 2013

(54) SYSTEMS AND METHODS FOR ELECTRONIC COUPON TARGETING

(71) Applicants: Michael D. Libenson, Belmont, MA (US); David A. Rochon, Waban, MA (US); Gregory T. White, Carlisle, MA (US)

(72) Inventors: Michael D. Libenson, Belmont, MA (US); David A. Rochon, Waban, MA (US); Gregory T. White, Carlisle, MA (US)

(73) Assignee: SAVINGSTAR

(21) Appl. No.: 13/531,300

(22) Filed: Jun. 22, 2012

Related U.S. Application Data
(60) Provisional application No. 61/500,287, filed on Jun. 23, 2011.

(51) Int. Cl. G06Q 30/02

(52) U.S. Cl. 705/14.25

(57) ABSTRACT

Described herein are methods and systems for implementing personalized targeting via electronic coupons, providing aggregate cap control of electronic coupons, implementing viral marketing using electronic coupons, and performing real time processing of electronic coupons.

### RELATED APPLICATION

This applications claims the benefit of and priority to U.S. Provisional Application No. 61/500,287, entitled “SYSTEMS AND METHODS FOR ELECTRONIC COUPON TARGETING, CAP CONTROL, VIRAL MARKETING AND INSTANT REWARDING” and filed on Jun. 23, 2011, which is incorporated herein by reference in its entirety for all purposes.

### FIELD OF THE DISCLOSURE

The disclosure generally relates to the field of electronic coupons. In particular, the methods and systems relate to various techniques for implementing personalized targeting, aggregate cap control of electronic coupons, viral marketing using electronic coupons, and real time processing of electronic coupons.

### BACKGROUND

Producers of consumer products may provide discounts on specific products via coupons, flyers or tokens which can be redeemed during purchase of the products. For example, such coupons may be distributed with newspapers and mailers. In some cases, coupons are delivered to a consumer electronically via email or in a webpage, and may be printed out for use in an instore purchase. Each coupon may specify a redemption value or discount subject to certain purchase conditions, such as required quantity and valid redemption time windows. Such discounts may be part of marketing efforts to introduce a new product or packaging, build brand recognition and loyalty, target specific consumers, or promote a product with specific retailers. The distribution and use of physical coupons, however, is generally cumbersome. Consumers, for example, have to clip and bring the physical coupon to a store for use, while physically maintaining the coupon in usable state and carefully keeping it from being lost or misplaced. Retailers may have to reject worn coupons, or inadvertently allow fraudulent redemption of illegally duplicated or counterfeit coupons. Producers, on the other hand, may not be able to precisely direct coupons to targeted individuals, or to accurately track the distribution and use of coupons.

### SUMMARY OF THE DISCLOSURE

Described herein are methods and systems for implementing personalized targeting via electronic coupons, providing aggregate cap control of electronic coupons, implementing viral marketing using electronic coupons, and performing real time processing of electronic coupons. A electronic coupon platform for generating and managing digital or electronic coupons (hereafter sometimes generally referred to as “ecoupons” or “coupons”) may provide ecoupons to a consumer having a registered user account associated with the ecoupon platform, or a store rewards card program. An ecoupon may specify a product or service, and may be redeemed against a purchase of the product or service. The ecoupon may be referred to as a UPC level or transaction level ecoupon, and can specify a specific brand, type, make, batch, packaging, and/or quantity of the product to be purchased for redemption of a coupon discount or credit to occur. The platform may associate, link or attach these ecoupons to a consumer via any type and form of user identifier including but not limited to store loyalty or rewards programs, credit card, phone number, pin number, user code, barcode, email address, contact information, etc. For example, the consumer or user may register a store loyalty or rewards card with the ecoupon platform. In some embodiments, the platform identifies the user via use of the user's store card during the purchase. Responsive to the identification, and upon completion of a purchase transaction of a product specified on an ecoupon, the platform may allow redemption of the ecoupon.

In some embodiments, the user may be asked to pay the full price of the product to complete the instore purchase transaction. Redemption of the ecoupon may be processed after the transaction is completed, or during the transaction itself. Redemption may, for example, be in the form of credits or cash value, which the user may opt to receive in the form of a credit, gift card, rebate, bank deposit, check, or applied towards a future purchase, or even gifted to a charity. In some embodiments, the platform communicates with the retailer to confirm the purchase transaction, and thereafter processes the ecoupon redemption. By tracking user behavior and purchase history via the redemption of ecoupons across one or more retailers, locations and mediums, preferences and insights at the user-level may be generated. These may be maintained and updated as personalized data for a specific user. Using such personalized data, the user may be identified for targeted marketing or individualized rewards. For example, a web portal may detect that a user is visiting its web pages. The web portal, in communication with an advertisement server, advertisement exchange and/or the ecoupon platform, may receive an advertisement (hereafter sometimes generally referred to as “ad”) or ecoupon selected based on the user's personalized data. By way of illustration, an ecoupon application (“app”) residing on the user's mobile device may locate and identify a user shopping in a retail store and may offer related ads, promotions or ecoupons via the app.

In another aspect, the ecoupon platform may allow a consumer product marketer or a retailer to design an ecoupon campaign by granular tracking of previous purchases, ecoupon downloads and/or redemption. For example, a campaign sponsor may specify a certain budget for an ecoupon campaign, or may choose to end a campaign once a certain target is met. The ecoupon platform can allow tracking of ecoupon usage and distribution across multiple users, retailers, locations and mediums. For example, the ecoupon platform can perform cap control of ecoupon redemption by a user, between retailers, and/or over certain periods of time. The ecoupon platform can allocate cap control limits for one or more mediums, for example, to target different market segments. The ecoupon platform can track redemptions and inactivate an ecoupon when a cap control limit or specific target is reached.

In yet another aspect, the ecoupon platform may provide viral affiliate and multi-level ecoupon solutions, e.g., in marketing, tracking and/or providing consumer rewards. By allowing registered users to download a trackable ecoupon, and encouraging the distribution of the ecoupon, the platform can track the distribution and/or redemption of the ecoupon by any number of downstream users. For example, a tracking cookie, uniform resource locator (URL) or code may be embedded in the ecoupon. The tracking code may store an identifier of the originating user and/or any intermediate users in the distribution chain as the ecoupon is distributed. Such an ecoupon may be distributed or shared via social media, email, instant messaging, inter-device communications (e.g., Bluetooth transmissions between cell phones). A rewards program may incentivize a user to distribute an ecoupon by attributing a downstream redemption back to the user. The attribution may include contributing a portion of the redeemable value from the ecoupon, or any other benefit to an originating user. By tracking the viral spread behavior of an ecoupon via specific users, the ecoupon platform may be able to identify effective channels for ecoupon or ad campaigns. Campaign sponsors may also be able to gain insight and analytics for tailoring or expanding marketing campaigns, for example to complementary mediums.

In still another aspect, the ecoupon platform may be in communication with a monitoring agent for receiving transaction information in real time or substantially in real time. The transaction information may be used to detect redemption of coupons, and also update redeemed credits to a user's account during or after a purchase transaction. In some embodiments, the transaction information may help the platform determine if coupon stacking and/or instore coupon-doubling may be occurring. In some embodiments, the platform may prevent coupon stacking, e.g., of paper and electronic coupons. The platform can also collect information such as instore promotions and sale prices that can influence consumer behavior. During or following a specific transaction, the ecoupon platform may provide customized promotions, ecoupons or targeted ads to the consumer based on the user's profile and/or the transaction. For example, an ecoupon related to a purchase may be transmitted to an ecoupon app executing on the user's mobile device. In some cases, the platform may be able to process the redemption during a transaction and authorize a payout to the retailer towards the purchase price of a product.

Aspects and implementations of the present disclosure are directed to systems and methods of electronic redemption, personalized targeting, distribution tracking, and cap control of redemption of electronic coupons. In general, in some implementations, a data processing system processes information related to, or contained within, Universal Product Code (UPC) based electronic coupons. In some methods and systems, information is obtained by one or more data servers from a point of sale (POS) system as a transaction involving an electronic coupon is being transacted.

At least one aspect is directed to methods for electronic coupon redemption based on transactional information received during a transaction at a point of sale system. The methods include receiving, by a server via one or more networks, transaction information from a point of sale (POS) system as a transaction is being transacted for a user at the POS system. The methods include determining, by the server based on the transaction information and while the transaction is being transacted, one or more electric coupons of the user to be redeemed based on the transaction. The methods include transmitting, by the server via one or more networks, an electronic receipt to a device of the user, the electronic receipt identifying the transaction information from the POS system and the one or more electric coupons redeemed for the user for the transaction.

The methods for electronic coupon redemption based on transactional information received during a transaction at a point of sale system may further include receiving, by the server, transaction information intercepted from the POS system by a monitoring agent, the monitoring agent transmitting the transaction information via the one or more networks to the server. Methods may further include receiving, by the server, transaction information identifying Universal Product Code (UPC) level information about a product or service being purchased by the user via the transaction at the POS system.

The methods for electronic coupon redemption based on transactional information received during a transaction at a point of sale system may further include validating, by the server, the transaction information against one or more electronic coupons of the user stored in an account managed by the server. Methods may further include redeeming, by the server, the one or more electronic coupons of the user via an account managed by the server, the account tracking the one or more electronic coupons of the user. Methods may further include transmitting, by the server, to a device of the user, a message about a status of redemption of the one or more electronic coupons for the transaction. Methods may further include determining, by the server prior to completion of the transaction, an amount redeemable by the user for payment towards the transaction.

The methods for electronic coupon redemption based on transactional information received during a transaction at a point of sale system may further include transmitting, by the server prior to completion of the transaction at the POS system, an electronic receipt to the device of the user.

The methods for electronic coupon redemption based on transactional information received during a transaction at a point of sale system may further include authorizing, by the server, to apply a cash value of a redeemed electronic coupon to a purchase of the transaction as partial payment. The method may further include communicating with the POS system to apply the cash value towards the purchase price for the transaction.

At least one aspect is directed to systems for electronic coupon redemption based on transactional information received during a transaction at a point of sale system. The systems include a server receiving, via one or more networks, transaction information from a point of sale (POS) system as a transaction is being transacted for a user at the POS system. The systems include an electronic manager of the server determining, based on the transaction information and while the transaction is being transacted, one or more electric coupons of the user to be redeemed based on the transaction. The server transmits, via one or more networks, an electronic receipt to a device of the user, the electronic receipt identifying the transaction information from the POS system and the one or more electric coupons redeemed for the user for the transaction.

In some implementations of the systems for electronic coupon redemption based on transactional information received during a transaction at a point of sale system, the server receives transaction information intercepted from the POS system by a monitoring agent, the monitoring agent transmitting the transaction information via the one or more networks to the server. In some implementations of the systems, the transaction information comprises Universal Product Code (UPC) level information about a product or service being purchased by the user via the transaction at the POS system.

In some implementations of the systems for electronic coupon redemption based on transactional information received during a transaction at a point of sale system, the electronic coupon manager validates the transaction information against one or more electronic coupons of the user stored in an account managed by the server. In some implementations of the systems, the electronic coupon manager redeems the one or more electronic coupons of the user via an account managed by the server, the account tracking the one or more electronic coupons of the user. In some implementations of the systems, the server transmits to a device of the user a message about a status of redemption of the one or more electronic coupons for the transaction. In some implementations of the systems, the electronic coupon manager determines, prior to completion of the transaction, an amount redeemable by the user for payment towards the transaction.

In some implementations of the systems for electronic coupon redemption based on transactional information received during a transaction at a point of sale system, the server transmits, prior to completion of the transaction at the POS system, an electronic receipt to the device of the user.

In some implementations of the systems for electronic coupon redemption based on transactional information received during a transaction at a point of sale system, the server authorizes to apply a cash value of a redeemed electronic coupon to a purchase of the transaction as partial payment. The POS system may receive the authorization to apply the cash value towards the purchase price for the transaction.

At least one aspect is directed to methods for personalized electronic coupon targeting based on offline Universal Product Code (UPC) tracking The methods include receiving, by a server via one or more networks from one or more point of sale (POS) systems, Universal Product Code (UPC) transaction information attributable to a specific user making offline transactions at one or more stores associated with the one or more POS systems. The methods include analyzing, by the server, behavior of the specific user at a UPC level based on the UPC transaction information. The methods include updating, by the server, a user profile of the specific user based on the analysis. The methods include identifying, by the server, the specific user interacting with an online medium. The methods include determining, by the server based on the user profile, an electronic coupon campaign to be delivered via the online medium to the specific user.

The methods of personalized electronic coupon targeting based on offline Universal Product Code (UPC) tracking may further include receiving, by the server, UPC transaction information from the specific user making offline transactions at physical locations of the one or more stores via the one or more POS systems.

The methods of personalized electronic coupon targeting based on offline Universal Product Code (UPC) tracking may further include analyzing, by the server, behavior of the specific user at the UPC level to identify purchases of related goods or servers in transactions of the specific user. Methods may further include analyzing, by the server, behavior of the specific user at the UPC level to identify quantity of items purchased in the transaction of the specific user. Methods may further include analyzing, by the server, behavior of the specific user at the UPC level to identify one of time or frequency of visits to the one or more stores corresponding to the transactions of the specific user. Methods may further include analyzing, by the server, behavior of the specific user at the UPC level to identify items purchased in the connection with a promotion.

The methods of personalized electronic coupon targeting based on offline Universal Product Code (UPC) tracking may further include updating, by the server, the user profile to identify the specific user's preferences based on the analysis.

The methods of personalized electronic coupon targeting based on offline Universal Product Code (UPC) tracking may further include receiving, by the server, identification of the specific user from an online service provider, the online service provided providing the online medium via which the user is interacting. Methods may further include identifying, by the server, the specific user via a cookie.

The methods of personalized electronic coupon targeting based on offline Universal Product Code (UPC) tracking may further include delivering, by the server, an electronic coupon to the specific user via the online medium.

At least one aspect is directed to systems for personalized electronic coupon targeting based on offline Universal Product Code (UPC) tracking The systems include a server receiving, via one or more networks from one or more point of sale (POS) systems, Universal Product Code (UPC) transaction information attributable to a specific user making offline transactions at one or more stores associated with the one or more POS systems. The systems include an electronic coupon manager of the server analyzing behavior of the specific user at a UPC level based on the UPC transaction information and updating a user profile of the specific user based on the analysis. The server, responsive to identifying the specific user interacting with an online medium, determines, based on the user profile, an electronic coupon campaign to be delivered via the online medium to the specific user.

In some implementations of the systems for personalized electronic coupon targeting based on offline Universal Product Code (UPC) tracking, the server receives UPC transaction information from the specific user making offline transactions at physical locations of the one or more stores via the one or more POS systems.

In some implementations of the systems for personalized electronic coupon targeting based on offline Universal Product Code (UPC) tracking, the electronic coupon manager analyzes behavior of the specific user at the UPC level to identify purchases of related goods or servers in transactions of the specific user. In some implementations, the electronic coupon manager analyzes behavior of the specific user at the UPC level to identify quantity of items purchased in the transaction of the specific user. In some implementations, the electronic coupon manager analyzes behavior of the specific user at the UPC level to identify one of time or frequency of visits to the one or more stores corresponding to the transactions of the specific user. In some implementations, the electronic coupon manager analyzes behavior of the specific user at the UPC level to identify items purchased in the connection with a promotion.

In some implementations of the systems for personalized electronic coupon targeting based on offline Universal Product Code (UPC) tracking, the electronic coupon manager updates the user profile to identify the specific user's preferences based on the analysis.

In some implementations of the systems for personalized electronic coupon targeting based on offline Universal Product Code (UPC) tracking, the server received identification of the specific user from an online service provider, the online service provided providing the online medium via which the user is interacting. In some implementations, the server identifies the specific user via a cookie.

In some implementations of the systems for personalized electronic coupon targeting based on offline Universal Product Code (UPC) tracking, the server delivers an electronic coupon to the specific user via the online medium.

At least one aspect is directed to methods for tracking viral distribution of Universal Product Code (UPC) based electronic coupons. The methods include generating, by a server, a tracking code unique to a first user for tracking Universal Product Code (UPC) based electronic coupons distributed by the first user. The methods include embedding, by the server, the tracking code into an electronic coupon offered to the first user, the electronic coupon identifying a UPC. The methods include receiving, by the server, a redemption of the electronic coupon by a second user, the second user receiving the electronic coupon from the first user. The methods include identifying, by the server from the redemption of the electronic coupon, the first user via the tracking code. The methods include attributing, by the server to the first user, the redemption of the electronic coupon by the second user.

The methods for tracking viral distribution of Universal Product Code (UPC) based electronic coupons may further include generating, by the server, the tracking code to include an identifier of the first user.

The methods for tracking viral distribution of Universal Product Code (UPC) based electronic coupons may further include embedding, by the server, program code into the electronic coupon that executes when the electronic coupon is one of shared, accepted or used by another user.

The methods for tracking viral distribution of Universal Product Code (UPC) based electronic coupons may further include receiving, by the server, the redemption of the electronic coupon by the second user who received the electronic coupon via a first mode of a plurality of modes of distribution. The methods may include receiving, by the server, an acceptance of the electronic coupon by the second user.

The methods for tracking viral distribution of Universal Product Code (UPC) based electronic coupons may further include identifying, by the server from the redemption of the electronic coupon, a mode of distribution of the electronic coupon from the first user to the second user. The methods may include tracking, by the server, via redemptions of the electronic coupon by a plurality of users, distribution of the electronic coupon by the first user via the plurality of users.

The methods for tracking viral distribution of Universal Product Code (UPC) based electronic coupons may further include attributing, by the server, redemption of the electronic coupon to the first user responsive to validating redemption of the electronic coupon by the second user. The methods may include attributing, by the server, a portion of a redeemable value of the electronic coupon to the first user.

The methods for tracking viral distribution of Universal Product Code (UPC) based electronic coupons may further include analyzing, by the server, one or more of the following for the electronic coupon: rate of distribution, rate of redemption, and mode (or modes) of distribution.

At least one aspect is directed to systems for tracking viral distribution of Universal Product Code (UPC) based electronic coupons. The systems include a server generating a tracking code unique to a first user for tracking Universal Product Code (UPC) based electronic coupons distributed by the first user. The systems include an electronic coupon generator embedding tracking code into an electronic coupon offered to the first user, the electronic coupon identifying a UPC. The systems include an electronic coupon manager receiving a redemption of the electronic coupon by a second user, the second user receiving the electronic coupon from the first user and identifying, from the redemption of the electronic coupon, the first user via the tracking code. The server attributes, to the first user, the redemption of the electronic coupon by the second user.

In some implementations of systems for tracking viral distribution of Universal Product Code (UPC) based electronic coupons, the tracking code comprises an identifier of the first user.

In some implementations of systems for tracking viral distribution of Universal Product Code (UPC) based electronic coupons, the electronic coupon comprises program code that executes when the electronic coupon is one of shared, accepted or used by another user.

In some implementations of systems for tracking viral distribution of Universal Product Code (UPC) based electronic coupons, the electronic coupon is received by the second user from the first user via a first mode of a plurality of modes of distribution. In some implementations, the electronic coupon manager receives an acceptance of the electronic coupon by the second user.

In some implementations of systems for tracking viral distribution of Universal Product Code (UPC) based electronic coupons, the electronic coupon manager identified via the redemption of the electronic coupon, a mode of distribution of the electronic coupon from the first user to the second user. In some implementations, the server tracks, via redemptions of the electronic coupon by a plurality of users, distribution of the electronic coupon by the first user via the plurality of users.

In some implementations of systems for tracking viral distribution of Universal Product Code (UPC) based electronic coupons, the server attributes redemption of the electronic coupon to the first user responsive to validating redemption of the electronic coupon by the second user. In some implementations, the server attributes a portion of a redeemable value of the electronic coupon to the first user.

In some implementations of systems for tracking viral distribution of Universal Product Code (UPC) based electronic coupons, the server analyzes one or more of the following for the electronic coupon: rate of distribution, rate of redemption, and mode (or modes) of distribution.

At least one aspect is directed to methods for cap control of redemption of Universal Product Code (UPC) based electronic coupons across an aggregate of a plurality of different mediums. The methods include identifying, by a server, a cap limit for an electronic coupon campaign, the electronic coupon campaign offering a Universal Product Code (UPC) based electronic coupon to a plurality of different users across a plurality of different mediums.

The methods include tracking, by the server, a total number of completed redemptions of the Universal Product Code (UPC) based electronic coupon by the plurality of different users across the plurality of different mediums. The methods include receiving, by the server, a request to redeem the Universal Product Code (UPC) based electronic coupon by a user of the plurality of different users via a medium of the plurality of different mediums. The methods include determining, by the server, whether the total number of completed redemptions has reached the cap limit.

The methods for cap control of redemption of Universal Product Code (UPC) based electronic coupons across an aggregate of a plurality of different mediums may further include identifying, by the server, the cap limit based on a budget for the electronic coupon campaign. The methods may include identifying, by the server, the cap limit based on one or more of the following factors: distribution rate, redemption rate and redemption processing period.

The methods for cap control of redemption of Universal Product Code (UPC) based electronic coupons across an aggregate of a plurality of different mediums may further include tracking, by the server, a number of completed redemptions across each medium of the plurality of different mediums. The methods may include aggregating, by the server, redemption statistics across the plurality of different mediums.

The methods for cap control of redemption of Universal Product Code (UPC) based electronic coupons across an aggregate of a plurality of different mediums may further include receiving, by the server, the request to redeem the Universal Product Code (UPC) based electronic coupon during a transaction for a product or service corresponding to the UPC

The methods for cap control of redemption of Universal Product Code (UPC) based electronic coupons across an aggregate of a plurality of different mediums may further include determining, by the server, that the total number of completed redemptions is within a predetermined threshold of the cap limit and responsive to the determination, updates one or more of the plurality of different users that the cap list is within the predetermined threshold of being reached. The methods may include determining, by the server, that the total number of completed redemptions has reached the cap limit and responsive to the determination, not redeeming the UPC based electronic coupon. The methods may include determining, by the server, that the total number of completed redemptions has not reached the cap limit and responsive to the determination, redeeming the UPC based electronic coupon. The methods may include allowing or denying, by the server, the request to redeem based on the determination.

At least one aspect is directed to systems for cap control of redemption of Universal Product Code (UPC) based electronic coupons across an aggregate of a plurality of different mediums. The systems include a server identifying a cap limit for an electronic coupon campaign, the electronic coupon campaign offering a Universal Product Code (UPC) based electronic coupon to a plurality of different users across a plurality of different mediums. The systems include an electronic coupon cap controller of the server tracking a total number of completed redemptions of the Universal Product Code (UPC) based electronic coupon by the plurality of different users across the plurality of different mediums. The server receives a request to redeem the Universal Product Code (UPC) based electronic coupon by a user of the plurality of different users via a medium of the plurality of different mediums. The electronic coupon cap controller determines whether the total number of completed redemptions has reached the cap limit.

In some implementations of systems for cap control of redemption of Universal Product Code (UPC) based electronic coupons across an aggregate of a plurality of different mediums, the server identifies the cap limit based on a budget for the electronic coupon campaign. In some implementations, the server identifies the cap limit based on one or more of the following factors: distribution rate, redemption rate and redemption processing period.

In some implementations of systems for cap control of redemption of Universal Product Code (UPC) based electronic coupons across an aggregate of a plurality of different mediums, the electronic coupon cap controller tracks a number of completed redemptions across each medium of the plurality of different mediums. In some implementations, the electronic coupon cap controller aggregates redemption statistics across the plurality of different mediums.

In some implementations of systems for cap control of redemption of Universal Product Code (UPC) based electronic coupons across an aggregate of a plurality of different mediums, the receives the request to redeem the Universal Product Code (UPC) based electronic coupon during a transaction for a product or service corresponding to the UPC.

In some implementations of systems for cap control of redemption of Universal Product Code (UPC) based electronic coupons across an aggregate of a plurality of different mediums, the electronic coupon cap controller determines that the total number of completed redemptions is within a predetermined threshold of the cap limit and, responsive to the determination, the server updates one or more of the plurality of different users that the cap list is within the predetermined threshold of being reached. In some implementations, the electronic coupon cap controller determines that the total number of completed redemptions has reached the cap limit and responsive to the determination, the server does not redeem the UPC based electronic coupon. In some implementations, the electronic coupon cap controller determines that the total number of completed redemptions has not reached the cap limit and responsive to the determination, the server redeems the UPC based electronic coupon. In some implementations, the electronic coupon cap controller allows or denies the request to redeem based on the determination.

The features and advantages described in the specification are not all inclusive and, in particular, many additional features and advantages will be apparent to one of ordinary skill in the art in view of the drawings, specification, and claims. Moreover, it should be noted that the language used in the specification may be principally selected for readability and instructional purposes, and may not have been selected to delineate or circumscribe the disclosed subject matter.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein

FIG. 2 is a block diagram that depicts an embodiment of an electronic coupon platform;

FIG. 3A is a block diagram of an embodiment of a system for personalized targeting using UPC level electronic coupons;

FIG. 3B is a flow diagram of an embodiment of a method of personalized targeting using UPC level electronic coupons;

FIG. 4A is a block diagram of an embodiment of a system for viral marketing, tracking and redemption of UPC level electronic coupons;

FIG. 4B is a flow diagram of an embodiment of a method for viral marketing, tracking and redemption of UPC level electronic coupons;

FIG. 5A is a block diagram of an embodiment of a system for aggregate cap control of UPC level electronic coupons;

FIG. 5B is a flow diagram of an embodiment of a method aggregate cap control of UPC level electronic coupons;

FIG. 6A is a block diagram of an embodiment of a system for instant reward and real time processing based on redemption of a UPC level digital coupon; and

FIG. 6B is a flow diagram of an embodiment of a method for instant reward and real time processing based on redemption of a UPC level digital coupon.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a system, network and computing environment which may be useful for practicing embodiments described herein;
Section B describes embodiments of an electronic couponing platform;
Section C describes embodiments of systems and methods for online UPC level personalized targeting based on offline in-store UPC level user behavior;
Section D describes embodiments of systems and methods of Viral Affiliate and Multi-Level Digital Coupon Marketing, Tracking and Rewarding;
Section E describes embodiments of systems and methods for Aggregate Cap Control of UPC level digital coupon redemption across multiple different sites and media; and
Section F describes embodiments of systems and methods for instant reward and real time processing based on redemption of a UPC level digital coupon.

A. System, Computing and Network Environment

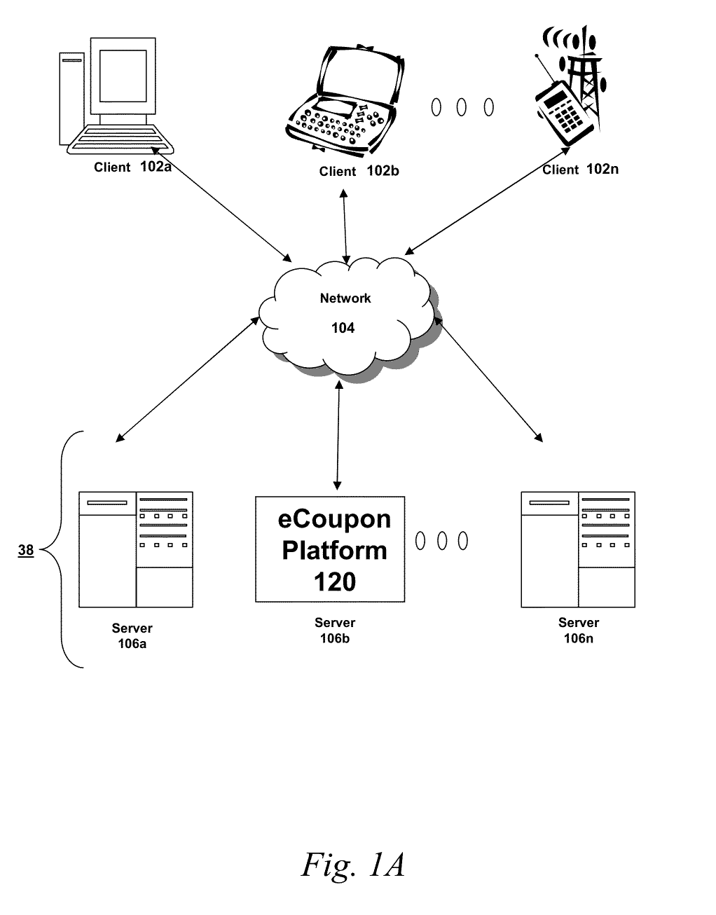

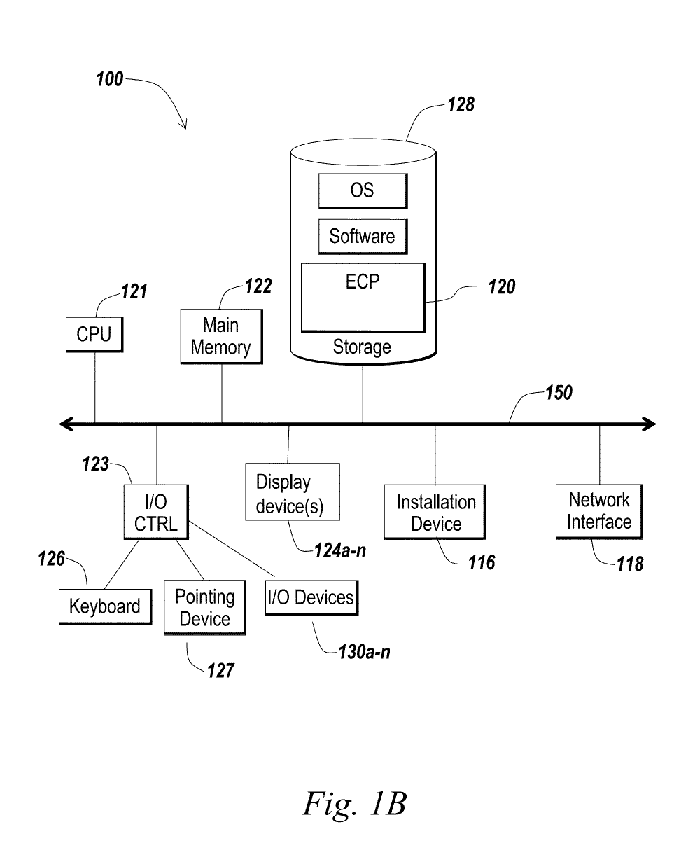

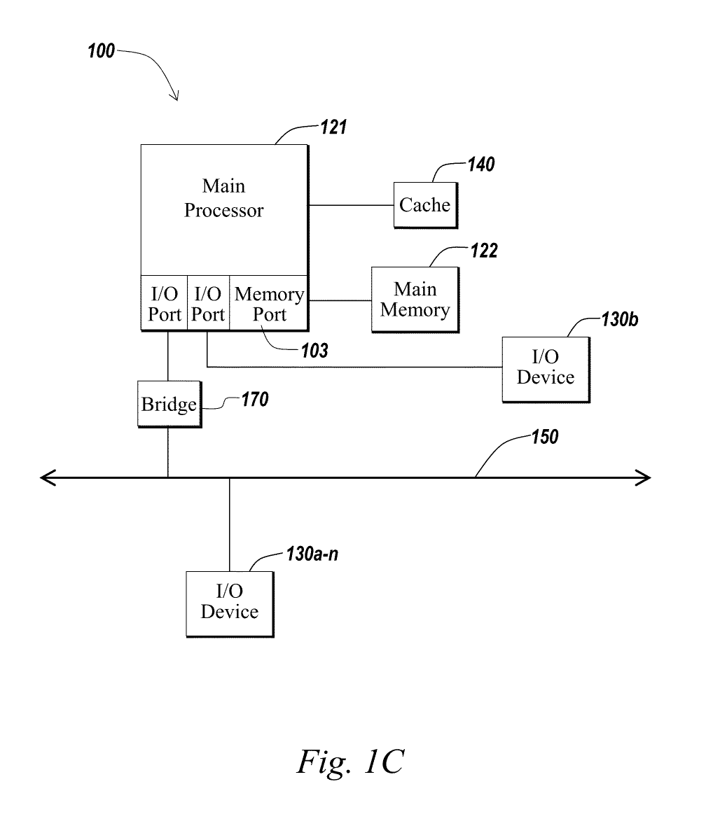

Prior to discussing specific embodiments of the digital or electronic coupon platform (ecoupon platform or ECP) of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 102 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In one embodiment, the server 106 provides the functionality of a web server. In another embodiment, the server 106a receives requests from the client 102, forwards the requests to a second server 206b and responds to the request by the client 102 with a response to the request from the server 106b. In still another embodiment, the server 106 acquires an enumeration of applications available to the client 102 and address information associated with a server 106′ hosting an application identified by the enumeration of applications. In yet another embodiment, the server 106 presents the response to the request to the client 102 using a web interface. In one embodiment, the client 102 communicates directly with the server 106 to access the identified application. In another embodiment, the client 102 receives output data, such as display data, generated by an execution of the identified application on the server 106.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse, finger, touch screen or pad, stylus, trackball, joy stick, controller and/or navigator. The storage device 128 may include, without limitation, an operating system, software, and a software of an electronic couponing platform (ECP) 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, drawing tablets, touch screen, touch pad, joy stick, controller, etc. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for the electronic couponing platform. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as a MP3 player manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Electronic Coupon Platform

Having discussed certain computing and operating environments that may be suitable for implementing some aspects of the present systems and methods, additional architectural and/or functional elements are described below, which can interoperate to implement various solutions via electronic couponing and tracking. Some of these solutions include (i) personalized targeting via electronic coupons, (ii) providing aggregate cap control of electronic coupons, (iii) implementing viral marketing using electronic coupons, and (iv) performing real time processing of electronic coupons.

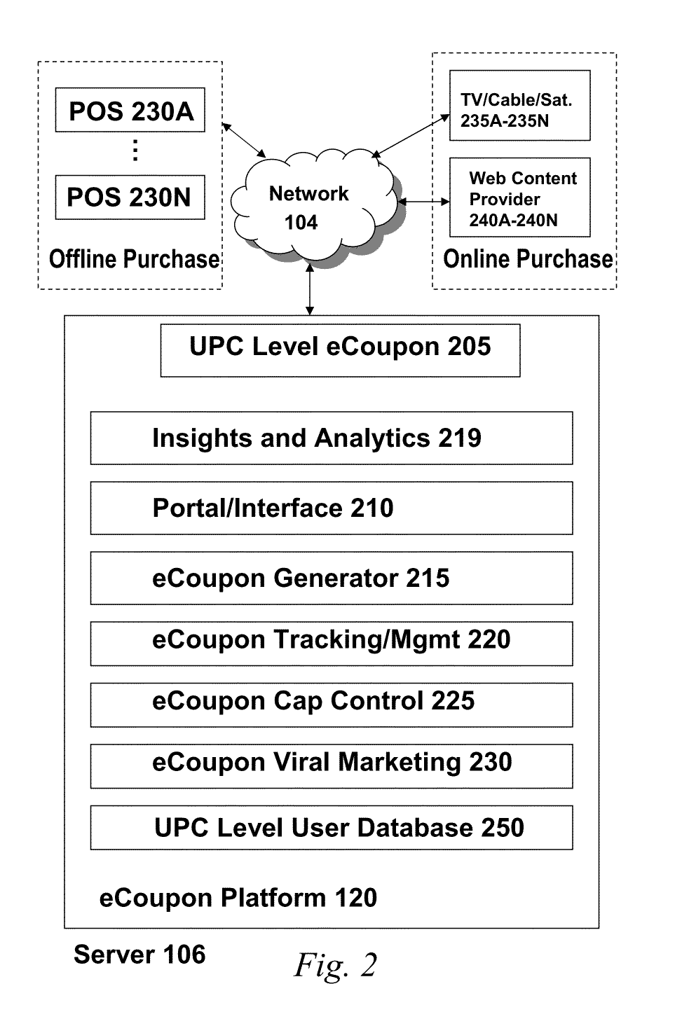

Referring to FIG. 2, one embodiment of a system for generating, managing and tracking electronic couponing is depicted. In brief overview, the system includes an electronic coupon platform 120, in communication with one or more point-of-sale (POS) systems 230 and/or media-based sales channels 235, 240 across one or more networks 104. The ecoupon platform may include one or more modules or interfaces, such as an insights and analytics engine 219, a portal interface 210, an ecoupon generator 215, an ecoupon tracking/management module 220, an ecoupon cap control unit 225, an ecoupon viral marketing module 230, and a UPC level user database.

In further details, the ecoupon platform 120 may comprise one or more computing devices, such as servers 106 and/or network appliances. The ecoupon platform 120, as well as any of its components (e.g., the portal interface 210, ecoupon generator 215, ecoupon tracking/management module 220, ecoupon cap control unit 225, and ecoupon viral marketing module 230) may be implemented in hardware or a combination of hardware and software. The ecoupon platform may include cloud computing capabilities, and may integrate functionalities and services from a number of network nodes. The ecoupon platform 120 may include any script, program, agent or component executing on one or more processors or cores. In some embodiments, the ecoupon platform 120 may have components operating at one or more layers of the network stack, such as the transport layer.

The ecoupon platform 120 may be built and configured for managing ecoupon features and/or processing ecoupon-related information to provide consumer insights and analytics. An ecoupon generator 215 of the platform 120 may generate or create an ecoupon based on a marketing or sales campaign of a sponsor or product manufacturer. The generator 215 may generate a certain number of ecoupons for distribution, e.g., based on campaign budgets, campaign goals, distribution metrics and/or redemption characteristics. The generator may include a tracking code or mechanism, such as a cookie or embedded URL, in an ecoupon. The generator may embed an expiration date, conditions qualifying redemption, etc, in the ecoupon. The ecoupon platform may distribute, advertise or offer an ecoupon to potential users via various channels. For example, the ecoupon platform may include a portal or website 210 that provides, advertises and/or offers ecoupons to consumers and/or users. An application or app installed on a user device can provide, advertise and/or offer ecoupons to users. A user can download and install an application on the user's device (e.g., a computer or a mobile device, such as a smartphone or tablet device). For example, the ecoupon platform, a loyalty program, a retailer, an app provider, and/or an app store may offer a mobile app for download, either. An app may be downloaded and/or used for free (e.g., via membership in a program or registration). In some embodiments, such an app may be purchased and/or used as part of a subscription service. Certain retailers or rewards/loyalty program may provide websites that display or list available ecoupons. Other channels may include email distribution (e.g., mailing lists, user-forwarded emails, targeted mailings, etc), electronic advertising on websites and/or social media, offerings through partners or membership services, propagation via viral affiliates, multimedia messaging and instant messaging, for example.

The ecoupon platform may provide ecoupons for download by a consumer having a registered user account with the platform or an affiliated store or program (e.g., rewards program). For example, a user may sign-up or register for an ecoupon account via a portal/interface 210 provided by the ecoupon platform 120. A consumer or user may download an ecoupon app to the user's device. The portal 210 and/or app may list or display ecoupons available to consumers. The portal 210 and/or app may arrange available ecoupons according to product and/or service categories, sponsor brands, newer/older ecoupons, active/expired ecoupons, redeemable value, etc. In certain embodiments, the portal and/or app may allow a user to arrange or sort ecoupons according to user criteria or preferences. In some embodiments, the portal and/or app may be in communication with an ecoupon management module 220 and/or an ecoupon cap control unit 225 to determine if an ecoupon is active or has expired. A user may sign-in or login to the user's account webpage via the app, the platform interface 210 or the website of an affiliated store or program. A user may access, select, or add ecoupons to the user's account by signing in and linking the ecoupons to the account or app.

The platform interface 210 may arrange or recommend ecoupons to a user (e.g., via the user's account webpage, or via an app), according to previous purchases, transactions and activities (e.g., linked to ecoupon use), the user's profile, preferences, past ecoupon selection or redemption, and other personalization information. In some embodiments, a user may communicate with the platform portal/interface 210 and/or access the user's account via an application or app installed on a device (e.g., computer, smartphone, tablet, etc) operated by the user. The platform interface may routinely or otherwise update the app with ecoupons, ads, sales promotions and redemption status, for instance. In some embodiments, the app may send information about the user back to the platform via the interface 210. Such information may include the location of a user (e.g., in a store or in the vicinity of a store, via GPS), and a webpage that the user is visiting or has visited. In some embodiments, the platform interface 210 provides real time updates to a user via the app, such as redemption status or ecoupon offers while a purchase transaction is ongoing.

In some embodiments, the ecoupon platform sends information to or updates the app. This may be initiated by the ecoupon platform and/or a partner entity (e.g., a retailer, ad server, loyalty program administrator), or by the user (e.g., starting an ecoupon app, searching for an ecoupon, requesting account information, etc). The ecoupon platform may send information or updates in real time as they are generated or become available, or according to a schedule. Such information or updates may be sent silently and/or routinely (e.g., updated ecoupon redemption statistics, daily list of new ecoupons, to an app or via email), intended to alert the user (e.g., of the use of an expired ecoupon, or availability of an ecoupon for immediate use in a store, via the app or an instant message), or otherwise (e.g., based on a transaction, real time generation and/or presentation of an electronic receipt or redemption status).

In certain embodiments, the platform 120 provides ecoupons to any identifiable or trackable consumers. For example and in one embodiment, the platform may provide ecoupons to an identified or registered member of a social media website, such as FACEBOOK or MYSPACE. The ecoupon platform 120 may provide an interface 210 to a social media website or an affiliate's website. Such an interface 210 may communicate with a downloadable plugin, app, or an API of the website to deliver ecoupons and/or update user account information. In some embodiments, the ecoupon platform may provide an ecoupon account to users of a particular membership network or community. For example, the platform may target consumers within a particular credit card network, a shopping network, rewards program or other membership community.

The ecoupon platform may associate, link or attach an ecoupon to a user or consumer via any user identification or association means, such as via a credit card, phone number, social media identifier (e.g., a Twitter account, username, avatar or other identifier), email address, employee number, bank account number, driver license number, student identification number, utility account number, mailbox number, address, registration number, skype identifier, IP address or other identifier of a device of the user, etc. For example, an ecoupon redemption may be processed for a user that provided any of such identification or association information during a transaction. For example, an online transaction involving an ecoupon may ask for an email address of the user (e.g., to send a confirmation email and/or to identify any ecoupon linked to the email address for processing). In some embodiments, a transaction is completed when a user is signed in (e.g., in Facebook), and so the user is readily identifiable via the user's account information. In another example, when a user uses the user's credit card in a transaction, ecoupons linked to the credit card may be identified and/or processed. In some embodiments, an online retailer may recognize a user via an IP address of the user's device used in a transaction. The online retailer and/or the ecoupon platform may identify if an ecoupon is linked to the user and redeemable in connection with the transaction.

The ecoupon platform may associate, link or attach these ecoupons to a user or consumer via store loyalty, rewards or other programs. For example, the consumer or user may register a store card (e.g., loyalty card, rewards card, discount card, membership card, credit card, debit or stored-value card, express check-out card, employee program card, perks card, etc) with the ecoupon platform. Although a store card can be used to link an ecoupon to a user, any type of user identifier, such as those described above, may be employed as an alternative or in combination.

Once an ecoupon is linked to a store card, loyalty/rewards program, or any other identification/association means, the user can use the ecoupon on a qualified purchase. When using an ecoupon, the user may be identified, for example, via use of the store card or by providing membership information in a loyalty/rewards program. For example, the user may swipe the user's store card to link a purchase to the user and the user's ecoupon. The user may receive credits or cash value from the ecoupon platform via the respective store card(s) or loyalty/rewards program(s). Further, and by way of illustration, a user may download a mobile device app that delivers ecoupons to the user. The app may facilitate linking of these ecoupons to the user's store card(s), loyalty/rewards program(s), ecoupon account and/or other identification/association means.

In further details, an ecoupon is an electronic coupon or digital coupon. The ecoupon may comprise a code, such as a bar code, Quick Response (QR) code, user code or any other type and form of identifier. In some embodiments, the ecoupon may specify a identifier such as a UPC code, but may or may not include the UPC bar code itself. The ecoupon may provide a discount off, reward or other value or benefit in connection with the ecoupon being redeemed for or with a product or services. An ecoupon may be loadable or loaded onto any type and form of storage or digital medium, such as a store loyalty card, portable storage device, mobile computing device, RFID tag or mobile payment device. An ecoupon may be linked to, identified by, or associated with any such storage or digital medium. In some embodiments, the ecoupon is not loaded onto a specific portable storage medium but associated with (e.g., linked to) and stored remotely from such medium. For example, the storage or digital medium may include an identifier corresponding to database location that identifies or stores the ecoupon. The a storage or digital medium may include an identifier to a user's account that identifies or stores the ecoupon.

The ecoupon may incorporate, in digital form, features of a traditional or physical coupon (e.g., clipped paper coupon). The ecoupon may include, or be represented by an image incorporating features of a traditional coupon. For example, the ecoupon may include an image of a featured product. The ecoupon may include description specifying the featured product, conditions for redemption, redeemable value, limitations to the use of the coupon, and so on. In some embodiments, the ecoupon and/or its description may be stored in an ecoupon database, e.g., hosted on a server or on the ecoupon platform. A URL, icon or image of an ecoupon, as displayed or listed on a webpage for example, may be linked to an ecoupon database. An ecoupon may be shared or conveyed digitally (e.g., via email) using such a URL, icon or image.

An ecoupon may specify a product or service, and may be redeemed against a purchase of the product or service. An ecoupon may specify a valid time period for redemption, which can be of any length and/or defined by a cap limit or an expiration date. The valid time period may be adjusted or updated electronically, since it is not constrained like a physical or paper coupon. An ecoupon may be specific to a particular product or service, and may include a brand, type, make, production batch, packaging, and/or quantity of the product or service to be purchased for redemption of a coupon discount or credit to occur. In some embodiments, an ecoupon with such specificity may be referred to as a UPC level ecoupon. The ecoupon may include or specify a UPC code, or other machine-readable or human-readable code. This ecoupon code may have to be matched against a UPC of a specific product or item for redemption to be allowed. For example, a scanner at a cashier station may scan for the ecoupon code as well as product codes of one or more items specified by the ecoupon. Upon receipt or verification of the scanned information, the ecoupon platform may assign, provide or deposit credits or cash value specified by the ecoupon to the corresponding user's account. In some embodiments, responsive to receiving a notification of the completed purchase or transaction, the ecoupon platform may assign credits or cash value specified by the ecoupon to the corresponding user's account. In certain embodiments, a UPC level ecoupon may be referred to as a transaction level ecoupon. Such an ecoupon may be redeemed based on a specific purchase or a collective purchase of multiple items. An ecoupon may be redeemed multiple times subject to conditions specified by the ecoupon. In some embodiments, an ecoupon may be processed during or after a transaction. At least a portion of the redeemable value may be provided in the form of immediate cash back, a credit back into the user's credit card account, a credit back into a gift/debit/stored-value card used in the transaction, a payment to the retailer for the transaction, for example.

A transaction may refer to any one or more steps for a purchase and/or redemption. A transaction may refer to transmission or processing of data associated with a purchase or redemption. In some embodiments, completion of a purchase of an item or service completes a transaction. The step or process of linking or associating a purchase to any user identification/association means, loyalty or rewards program (or card) may be a transaction by itself. In some embodiments, the purchase of each item or service each constitutes a separate transaction. In certain embodiments, the purchase of multiple items or services may occur in a single transaction. Each purchase or redemption process corresponding to a UPC level identification (e.g., scan) may constitute a transaction. In some embodiments, a transaction may refer to an identification of a UPC code on an ecoupon. A transaction may further include matching against a product or service specified by the ecoupon. For example, a transaction may include identification (e.g., UPC scan during a purchase) of a consumer product specified by an ecoupon. A transaction may include redemption of one or more coupons, rebates or other rewards during a purchase. Each redemption may also be referred to as a separate transaction. Such coupons, rebates or other rewards may be electronic or physical in form (e.g., an electronic copy displayed on the screen of a mobile device, an electronic copy wirelessly transmitted to a POS system, or a paper copy).

In some embodiments, an ecoupon 205 is electronically linked to a user (e.g., to the user's account or loyalty card), but do not have to be physically printed for use. An ecoupon may be listed, displayed or advertised for download via a webpage or other digital media (e.g., on an email). A user may “download” or “load” an ecoupon to a rewards, loyalty or membership card by logging into a corresponding user account, through which the ecoupon is linked and/or tracked for use. For example, a store (e.g., Kroger) website may offer ecoupons for download. A user may sign-up for a store card (e.g., rewards, loyalty, credit or membership card) and an associated account. The user may select an offered ecoupon from the webpage, which may include a link to sign in to the user's account. Once the sign-in is successful, the ecoupon is linked to the store card and may be ready for use.

The ecoupon may or may not be transmitted to a POS system during a transaction. It may not be necessary for the ecoupon to be displayed or presented to a POS system during a purchase of a specified product. It may not be necessary for an ecoupon to reside in a store card of a user, or a mobile device of the user. In some embodiments, the ecoupon is linked or matched to a purchase after the purchase transaction is completed. As such, redemption of an ecoupon may occur after a purchase transaction is completed. Thus, a user may pay the full, listed, store or undiscounted price of a product or service at the time of the purchase. The user may receive credit or cash value some time after the purchase, e.g., when the ecoupon platform processes and validates the redemption. In some embodiments, the platform may be in communication with the retailer to confirm the purchase transaction, and thereafter process the ecoupon redemption. The platform may request one or more retailers for transaction information related to specific loyalty/rewards programs, time periods, users, use of ecoupons, purchase of specific products (e.g., at the UPC level), for example. In some embodiments, the platform receives raw or non-specific information from a retailer which the platform parses to identify ecoupon redemptions and/or other information.

In yet other embodiments, an ecoupon 205 may be presented to a POS system, and may be processed and/or redeemed in real time. The platform may optionally or selectively allow real time processing of an ecoupon depending on the type or identity of the ecoupon, retailer, store card, rewards programs, user, ecoupon sponsor, campaign, POS system, transaction, and transaction support, for instance. In some instances, real time processing can include authorization by the platform to apply redeemed cash value directly to a purchase transaction as partial payment. Based on a qualified purchase, an instore POS system may provide transaction information in real time to the ecoupon platform, such as during or upon completion of the transaction. In other embodiments, the POS system may deliver the transaction information according to a schedule or based on predetermined events (e.g., upon polling by the platform, or when a certain volume of transaction information have accrued at the retailer).

A retailer may report or share transaction information on a user based on transactional history tracked against the user's store card usage or other instore membership program. The ecoupon platform may store and maintain some or a portion of this transaction information in a database 250. In some embodiments, the ecoupon platform may request for transaction information related to specific users, e.g., identified via store cards or other membership programs linked to ecoupons selected by these users. The ecoupon platform database 250 may store UPC level user information. The platform 120 may parse and extract transaction information at the UPC level, such as information related to a purchase of a specific product description tied to a UPC. UPC level information may include the store price, instore promotion, sales tax, and other information specific to the product. UPC level information may include related information such as store location, time and date of the purchase, the quantity of the specified product purchased (e.g., independent of the redemption limits specified by an ecoupon), other items purchased during the transaction, total amount spent for the transaction, rewards or other coupons redeemed, payment type (e.g., cash, check, gift card or types of credit cards), instore or online purchase, etc.

Redemption of the ecoupon may be processed after the transaction is completed, or during the transaction itself. In some embodiments, responsive to a purchase of a product specified on an ecoupon, including any quantity and/or combination of products over one or more transactions or over time (e.g., one or more items in a shopping cart or basket, whether purchased, removed, unpurchased or stored for later purchase), the platform may allow redemption of the ecoupon linked to the purchaser. An ecoupon tracking/management module 220 (hereafter sometimes referred to as an ecoupon manager) may determine if a redemption is valid before authorizing the redemption. For example, the ecoupon manager may determine (e.g., by accessing information in the database 250) if the purchase was completed during the valid or promotional period specified for the ecoupon. The ecoupon manager may determine if the quantity limit for redemption has been exceeded for a single transaction or user. The ecoupon manager may determine if an ecoupon has been previously used or redeemed by a user. The ecoupon manager may determine if coupon stacking is allowed. An ecoupon may allow coupon stacking in some cases. For example, one ecoupon may allow redemption from the ecoupon and a paper coupon on a single purchase. Another ecoupon may disallow coupon stacking or may limit the amount redeemable. In some embodiments, an ecoupon cap control unit 225 of the platform 120 determines if a purchase occurred after a cap limit has been reached. The cap control unit 225 may indicate to the ecoupon manager 220 whether to allow a redemption based on the determination.

Redemption may, for example, be in the form of credits, loyalty points, rebates, cash value, instant cashback, credit back to a credit/debit/cash/gift card, and/or non-cash rewards such as gifts, products or services. In some embodiments, the user may opt to make the redemption in the form of any one or more of a gift card, rebate, voucher, discount, bank deposit, check, and a credit towards a bill or future payment. A user may have some portion of the redeemed value applied towards a present or future purchase. In certain embodiments, a user may opt to gift some portion of the redeemed value to a charity, e.g., of the user's choice. A user may, in some embodiments, redeem some portion of an ecoupon as rewards or loyalty points, for example, airline or hotel points. A user may choose to convert one of these redeemed forms into another form, for example, prior to usage and/or expiration. Conversion may be subject to certain restrictions and/or conditions, such as conversion limits, frequency of conversion, etc. In some embodiments, the redeemed value may be converted into stored value or available value in a rewards or store card, e.g., that the user used when redeeming an ecoupon.

One or more of these redemption choices may be predetermined by the platform, the user, the retailer, rewards program and/or the ecoupon sponsor. In some embodiments, a user may request a form or type of redemption not currently available through the platform. In certain embodiments, the user may choose to maintain redeemed value based on an ecoupon credit or point system. For example, the user may choose to maintain such value until it is above a specified level (e.g., 100 points) for conversion into a different form (e.g., a $100 gift card). In some embodiments, a user may gift a portion of the redeemed value in any form to another user, e.g., as a gift via FACEBOOK or other social media.

The ecoupon platform (e.g., via the ecoupon manager) may monitor, track and/or analyze a user's purchase of a product specified on an ecoupon, as well any quantity, type and/or combination of products (whether related or not) over one or more transactions or over a certain period of time (e.g., one or more items in a shopping cart or basket, whether purchased, removed, uncompleted or stored for later purchase), and/or related to one or more ecoupons. The ecoupon platform may provide redemption, rewards or other forms of benefits based on purchases over one or more transactions, baskets, shopping carts and/or retailers. In some embodiments, this may be referred to as “cross-basket” rewarding or redemption. Such cross-basket rewards or redemption may be in addition to ecoupon redemption, and in some embodiments, an alternative to ecoupon redemption.

In some embodiments, the ecoupon platform may track a purchase of a certain quantity of a featured or related product(s) in a transaction or store. The ecoupon platform may track one or more other purchases of the featured or related product in one or more other transactions and/or stores by the same user. The ecoupon platform may track the total amount spent on the purchases (e.g., dollar amount), the number of ecoupon redemptions and/or pattern of spending (e.g., spending trends, spending distribution across stores, geographical locations, etc). In certain embodiments, the ecoupon platform may reward the user (e.g., in any of the forms described herein) based on accumulated spending or frequency of ecoupon redemption, for example, over a period of time.

The ecoupon platform may reward the user based on the quantity of a feature and/or related product(s) bought over one or more transaction and/or stores. For example, the ecoupon or the ecoupon platform may provide for additional redeemable value if the user reaches a particular spend target or quantity purchases. In some embodiments, the ecoupon platform may reward a user with an additional percentage of the redeemed values if a user meets a quantity target over multiple transactions within a month. By way of illustration, a user may get a one-time 50% bonus based on ecoupon value redeemed over three transactions if the user meets a quantity target for buying a detergent product over the three transactions. In some embodiments, the ecoupon platform may reward a user with a fixed amount (e.g., bonus $2 redeemable value) if the user meets a quantity or spend target over multiple transactions within a time period. In certain embodiments, the ecoupon or the ecoupon platform may reward a user for every spend target and/or quantity target reached, e.g., over a specified period of time. Some of these rewards may be specific to spend or quantity targets for a particular retailer, service provider and/or medium, for example.

In some embodiments, cross-basket rewards may be awarded across various purchases, products and/or ecoupons. The rewards may not have to be tied to any particular ecoupon or UPC level transaction. For example, these rewards may be related to, or sponsored by a retailer, manufacturer or mall operator. By way of illustration, the ecoupon platform may provide a certain reward (e.g., a giftcard, waived membership fees, or a credit) if a user meets a certain spend target at a retailer (e.g., Costco, Macy's, Amazon.com) or a group or association of retailers, such as a particular shopping mall over a period of time.

The ecoupon platform may include a database 250 for storing any type or form of information. The database may comprise one or more storage modules having any embodiment of storage features 128, 122, 140 described above in connection with FIGS. 1B and 1C. The database may be centrally located on one device or distributed over one or more devices in communication with each other. For example, the database may be implemented as an storage area network (SAN). The database 250 may be configured to store and/or maintain data entries using particular data structures, formats, encryption and/or compression schemes, etc. In some embodiments, the database 250 stores information at the user-level, UPC level, transaction level, rewards program level, store-card level, retailer level, or any combination thereof. For example, for each user, the database may maintain a history of UPC-level transactions. These UPC-level transactions my be identified by the ecoupons linked to the user. In some embodiments, the platform may analyze the UPC-level transactions for user behavior. Such user behavior may processed into user-specific and/or consumer-segment insights and analytics.

In some embodiments, the ecoupon platform 120 may include an insights and analytics engine 219, hereafter sometimes generally referred to as the IA engine 219. The IA engine may communicate with the ecoupon manager 220, viral marketing module 230 and/or the database 250 to perform UPC level analysis of user behavior and transaction analysis. The IA engine may generate UPC level insights and analytics of specific users and/or groups of users. UPC level insights and analytics may be generated from user behavior tracked across retailers, products, locations, product categories, retail mediums (e.g., instore, online, TV-broadcast-initiated sales). In some embodiments, the IA engine communicates with third-party providers (e.g., BlueKai, Exelate and Axciom) for consumer segment information, insights and analytics, and/or other information. The IA engine may also receive, exchange or share user-level information, insights and analytics, e.g., with third-party providers. In certain embodiments, the IA engine may provide third-party providers with information, insights and analytics. Based on the user behavior, insights and analytics, the IA engine may interact with providers, such as those of web content 240, satellite/cable 235 or other types of services, to tailor a marketing event or opportunity to target a user or a group of consumers.

C. Personalized Online Targeting Based on Offline UPC Tracking

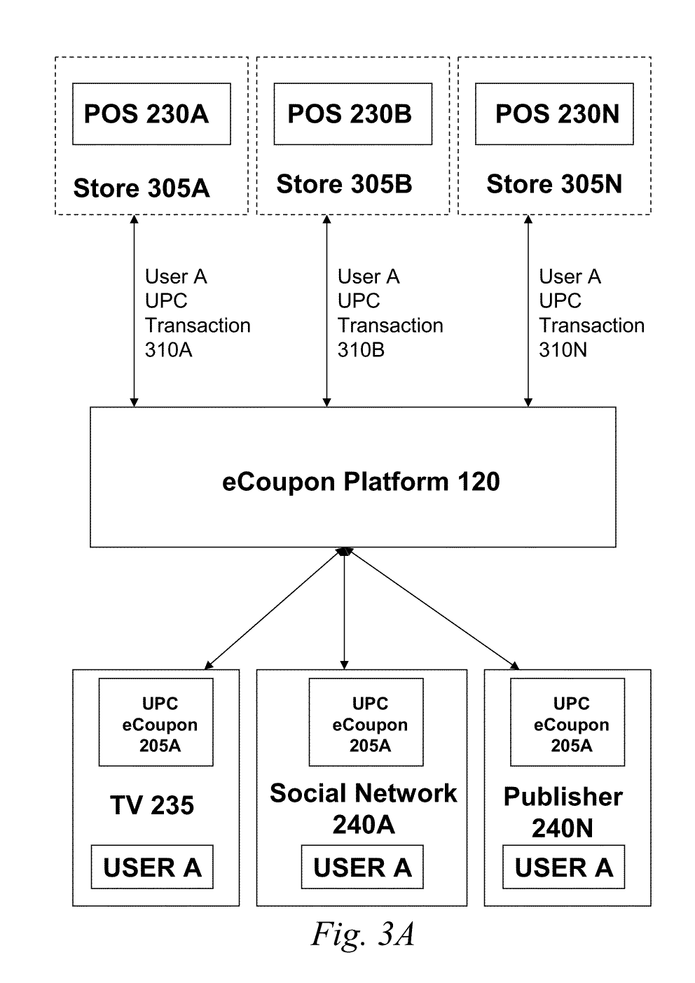

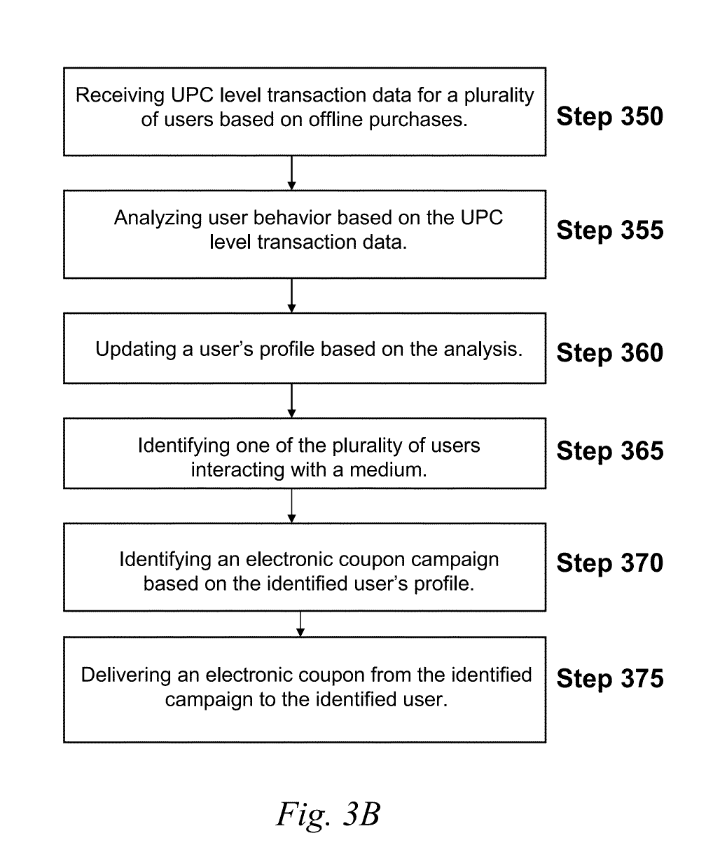

Referring now to FIGS. 3A and 3B, systems and methods for personalized online targeting based on offline UPC tracking is depicted. Embodiments of the present solution may track for each user the user's UPC level transactions at a plurality of different offline locations, such as retail stores and restaurants. The present solution may analyze the user's behavior via the UPC level transaction data and store the analysis or results therefrom to a use profile. As the user interacts with online mediums, such as web-sites and cable service, the present solution may personalize or target promotion or advertisement, such as UPC based electronic coupons, to the user based on the user's profile. As a result, the user's offline UPC level transactions in physical offline locations influences or is input to the targeting and/or personalization of electronic coupons to the user via online mediums.

Referring to FIG. 3A, one embodiment of a system for personalized online targeting based on offline UPC tracking is depicted. In brief overview, the system includes an ecoupon platform 120 in communication with one or more retailers, stores, service providers, content providers and/or ad agencies/exchanges. In some embodiments, each of the retailers, stores, service providers and/or content providers may perform a transaction 310 with a user, such as purchase of a product or service. Such a transaction 310 may be associated with an ecoupon, for example, via the use of a user's store card.

In further details, a store, retailer or service provider may include a POS, point of purchase (POP) or checkout system to initiate, process and/or complete a transaction 310. Such a system may include hardware and/or software, for example, a cash register or checkout terminal. The POS system may be manned by a salesperson or automated. In some embodiments, the POS system allows self-checkout by a customer. The POS system may include components to receive or extract information to process a transaction, such as a scanner to scan a UPC code on an item label, coupon, voucher, etc. A UPC code may also be scanned off a display of a mobile device, for example. A POS system may also include any other type or form of input or scanning device, such as a Radio Frequency Identification (RFID) reader (e.g., to read a “key chain” tag), a magnetic strip card reader, and a pattern recognition camera. For example, a consumer or user may be identified with a transaction by swiping a card (e.g., store card or credit card) at the POS system. A consumer or user can be identified by entering identification information into the POS system, such as a rewards program identification number.

In some embodiments, a store card or identification information may be shared by one or more related persons, such as family members or members of a small business. Accordingly, each transaction can be attributed to a specific user, or to a group of related persons. In certain embodiments, the ecoupon platform 120 may be configured to encourage or require the use of an ecoupon by a specific user rather than a group of individuals. For example, the platform 120 may only allow rewards programs targeted at individuals to be linked to an ecoupon, or may limit the types of ecoupons available for linking to non-individual rewards programs.

The ecoupon platform (e.g., via the ecoupon manager 220) may track transactions attributed to various users. The platform 120 may track or monitor one or more UPC level transactions 310A-N attributed to a user. A UPC level transaction may be for a specific good or service specified by a UPC code. Such a UPC code may be identified by an ecoupon linked to the user. In some embodiments, the platform may track or monitor offline transactions. Such offline transactions may be referred to as instore transactions. Offline transactions may include any type or form of transaction performed in person at a physical retail or service location. In some embodiments, offline transactions may include selections ordered online and completed or picked-up at a physical retail location. The ecoupon platform 120 may, in some embodiments, specifically target instore transactions by allowing registration of instore-only store cards and programs. In certain embodiments, the platform 120 may track or monitor any transaction (e.g., offline or online) attributable to user (e.g., identification via a store-specific user shopping account or a rewards program).

A store or retailer may include any type or form of retail outlet or location, such as a grocery store (e.g., Stop and Shop, Kroger, Safeway, Whole Foods,), departmental store (e.g., Macys, Neiman Marcus, Target, Walmart, etc), specialty store (e.g., Toys R Us, PepBoys, Best Buy, Coach, IKEA, Ethan Allen, Abercrombie and Fitch, Godiva, Disney, Gap, etc), membership discount store (e.g., Costco, BJ's), restaurants and food/beverage stores (e.g., Red Lobster, Chili's, Burger King, Morton's, Starbucks, Dunkin Donuts, etc), Pharmacies (e.g., CVS, Rite Aid) and others (e.g., Seven Eleven, TJ Maxx, etc). A store or retailer may include online stores or transaction services, such as Amazon, Ebay, Newegg, Overstock, and/or online counterparts to traditional store fronts (e.g., Stop and Shop Peapod, online Apple store).

A transaction with a service provider (e.g., Zoots) may be performed instore or online. In some embodiments, content providers may sell or trade products and/or services online (e.g., magazine or content subscriptions, advertised products related to published content, customized reports, storage space, music download, video streaming services, facilitate trading or transactions with third-parties, etc). Certain services, such as so-called “Deal-a-day” services like Groupon, LivingSocial and BuyWithMe, may offer discount deals to members. The ecoupon platform 120 may make ecoupons or e-vouchers available to such members for redemption or purchase of an offered deal. The ecoupon can, for example, be redeemed with the purchase of a Groupon deal. In another example, the Groupon may include an ecoupon for redemption at a restaurant, retailer or service provider.

In some embodiments, the ecoupon platform 120 receives transaction information from any offline entity, such as a restaurant, retailer, store, content-provider or service provider (hereafter sometimes generally referred to as “store”). The POS system of a store may collect any type of information pertaining to or related to a transaction. In some embodiments, the POS system may transmit some of all of the collected information to the ecoupon platform. The POS may provide or store collected transaction information (e.g., at the UPC level) to a central service or database of the store. For example, such a service or database may track the transactions and activities of loyalty club members. The ecoupon platform may request UPC level transaction or user behavior information from each store, for example, by providing loyalty club member identification information and/or UPC information. In some embodiments, non-POS systems or servers may transmit the transaction data to the ecoupon platform. Although at times, it is generally discussed as the POS system collecting and sending the transaction data, any system, server or device related to or in connection with the offline location may process and/or transmit the transaction data to the ecoupon platform.

The POS system, central service or database of a store may process and/or filter the transaction and user behavior information prior to delivery to the ecoupon platform 120. In some embodiments, a store may provide transaction or user behavior information based on specifics or a format requested by the platform. A store may provide some of the information in real time (e.g., during or contemporaneous with a transaction), based on a schedule, and/or in response to an event (e.g., a polling or request event by the ecoupon platform). In some embodiments, the information provided includes a user's transaction history over a period of time.

In some embodiments, instead of a store, an associated rewards program or loyalty program provides the transaction or user behavior information. In certain embodiments, administration of a rewards program or loyalty program may be performed by a third party (e.g., Cartera Commerce). Such a third party may include a credit card company affiliate or a shopping network affiliate. Yet other programs include memberships such as the Automobile Association of America (AAA) membership program which provides access to retail and service opportunities. Some programs may track a user's transaction history across multiple stores and transactions via multiple mediums (e.g., purchases online, instore, or via a cable provider).

The ecoupon platform 120 may interface, partner or communicate with various stores and programs to obtain, share or exchange UPC level transaction information of a user. The ecoupon platform ma interface, integrated or communicate via one or more networks with various stores and programs via such as via any corresponding servers, systems or applications. Accordingly, the platform 120 may track and analyze user transaction history across various stores, as well as various locations of each store. The platform 120 can also track user transaction history or behavior across different mediums, such as purchases initiated online but picked-up or completed instore, purchases initiated via a TV shopping network 235, video-on-demand purchases through a cable provider 235, and instore purchases and returns. User transaction and behavior information can include store preferences, geographical boundaries and concentrations for instore activities, frequency and time of store visits, quantity of items purchased, whether a purchase coincides with an instore or other promotion, occurrence of coupon stacking, spending amount and trends, purchase of related goods or services in the same or another transaction, the payment mode (e.g., cash, type of credit card), the level of ecoupon usage relative to each store visit, for example. Accordingly, user behavior, preferences, traits and other characteristics, both desirable and undesirable, may be tracked by the platform. The platform 120 may further perform tracking at a granular level, down to the UPC transaction level for each user and/or each UPC identified via or associated with a transaction. Such information may be collected and stored at the UPC level in the platform database 250.

By obtaining and tracking such information, the platform may analyze user behavior down to the UPC or transaction level. Via an IA engine 219, the platform 120 may parse, filter, organize or otherwise process the information into personalized information for each user, which may be stored in the platform database 250. Personalized information may include shopping habits, preferences and other characteristic condensed, simplified or arranged in an organized form, which may include frequency plots, trending graphs, geographical locations, transaction type or medium breakdown. The IA engine may create a user profile from the personalized information.

A user profile may include specific or inferred user preferences based on the user's transaction history, behavior and/or personalized information. The user profile may incorporate user information such as age, gender, marriage status, income level (e.g., provided by the user, or obtained from a registered program (e.g., reward program). A user profile may indicate or outline products, services, stores or brands that a user may like (e.g., aspirational) or need. A user profile may include information such as estimated spending power (e.g., based on spending pattern in various categories of goods and services), lifestyle preferences (e.g., health-conscious, brand-conscious, associated with pets, likes to dine or travel, likes outdoor activities), level of brand loyalty (e.g., whether the user is likely to try a different brand), and shopping habits (e.g., prefers to purchase based on convenience or price, or makes purchases on a regular or an ad hoc basis).

The platform 120 may store a user's personalized information and/or profile in the platform database 250. The platform may arrange or order user information according to users' names or other identification information. In some embodiment, the platform may assign a unique identifier to each user. For example, a user's identifier may be used to retrieve the corresponding user's profile or information from a hash table storing data of a plurality of users. The user identifier may be encoded in ecoupons that the user selected, distributed and/or redeemed. In some embodiments, the user identifier is encoded, tagged or embedded in a cookie as the user navigates online. The platform 120 may share or distribute the user identifier and/or user profile to service providers (e.g., Internet, TV, cable, satellite service providers) in order to identify, detect, recognize and/or track a user across various mediums. In some embodiments, the user may be identified for targeted or individualized marketing or rewards, e.g., based on the corresponding user profile. For example, a user may be identified as the user visits a particular web portal. The web portal, in communication with an ad server, ad exchange and/or the ecoupon platform, may receive an ad or ecoupon selected based on the user's personalized data. An ecoupon app residing on the user's mobile device may locate and identify a user (e.g., on behalf of the platform 120). For example, the platform 120 may detect that the user is shopping in a particular retail store and may offer suitable ads, promotions or ecoupons via the app to the user.

Illustrated in FIG. 3B is an embodiment of a method for personalized online targeting based on offline UPC tracking. In one embodiment, an ecoupon platform receives UPC level transaction data for a plurality of users based on offline purchases (Step 350). An IA engine of the ecoupon platform may analyze user behavior based on the UPC level transaction data (Step 355). The IA engine may update a user's profile based on the analysis (Step 360). The ecoupon platform may identify one of the plurality of users interacting with a medium (Step 365). The ecoupon platform may identify an electronic coupon campaign based on the identified user's profile (Step 370). The ecoupon platform may deliver an electronic coupon from the identified campaign to the identified user via the medium (Step 375).

Referring to step 350, and in some embodiments, an ecoupon platform receives UPC level transaction data for a plurality of users based on offline purchases. A server of the ecoupon platform may receive via one or more networks from one or more point of sale (POS) systems, Universal Product Code (UPC) transaction information attributable to a specific user making offline transactions at one or more stores or entities associated with the one or more POS systems. The POS systems may provide the UPC transaction information to one or more intermediary devices that provide such transaction information or portions thereof to the ecoupon platform. The server(s) of the ecoupon platform may receive UPC transaction information from the specific user making offline transactions at physical locations of one or more stores via one or more POS systems.

In certain embodiments, the ecoupon platform 120 polls or sends a request to a one or more stores and/or rewards program administrators for the transaction data. The UPC level information may be collected by each store or rewards program for each user, and may be filtered, parsed or processed prior to delivery to the ecoupon platform. In some embodiments, the ecoupon platform may request for specific types of UPC level transaction data. The platform may also request for the data to be arranged or delivered in a certain way or format. For example, the ecoupon platform may request for UPC level transaction data for one or more specific users, e.g., by identifying the rewards program identifier for these users.

The ecoupon platform may request for UPC level data for particular transactions, for example, transactions involving specific products or services having a UPC code specified by one or more ecoupons. The ecoupon platform may request for UPC level data for particular transactions occurring within a particular time period, e.g., during which an ecoupon is valid. The platform 120 may provide both the UPC and user information to the store or rewards program administrator when requesting for the UPC level transaction information. The ecoupon platform may request UPC level transaction data from a plurality of stores and/or rewards program administrators. The ecoupon platform may poll for or request UPC level transaction data according to a schedule (e.g., periodically once every week), based on the expiration of an ecoupon, and/or based on the volume of ecoupons distributed or redeemed, as examples.

The ecoupon may also request for any type of information related to the transaction, for example date, time, quantity of goods purchased, total spending, related items purchased, store promotions, concurrent use of other coupons or vouchers, store returns (e.g., of a product featured in an ecoupon), and the payment type for the transaction. In some embodiments, the ecoupon platform receives information according to a format supported by the store or rewards program administrator. The ecoupon platform may have to filter, parse, reformat or process the received information to obtain the UPC level transaction information. In some embodiments, each store or rewards program administrator may send the information at substantially the same time, or at a different time (e.g., when the information is available). The ecoupon platform may negotiate or arrange for an agreed time or schedule for which to deliver the information.

In some embodiments, the ecoupon platform requests for and/or receives UPC transaction level information of users based on offline purchases or transactions. Such transactions may be initiated, made and/or completed instore, that is, at a physical store. An instore purchase may include a pre-order online but completed transaction instore. An offline transaction may include any transaction for which a store card is swiped or scanned at a POS system instore. An offline transaction may include any transaction for which the user is identified at a POS system instore. An offline transaction may include transactions made over the phone, or through a cable/satellite/TV service provider. An offline transaction may include any transaction that is not initiated, conducted and/or completed online. In some embodiments, the ecoupon platform may receive information based on transactions that are initiated, conducted and/or completed online or via any other medium.

In further details of step 355, an IA engine of the ecoupon platform may analyze user behavior based on the UPC level transaction data. One or more servers of the ecoupon platform may analyze behavior of a specific user at a UPC level based on the UPC transaction information. Based on the transaction data of users received from various stores, locations, contexts and mediums, the IA engine may analyze the behavior of one or more users. The IA engine may organize or arrange transaction information from various sources for each user. The IA engine may consolidate data from various sources to build a transaction history for a user. The IA engine may extract transaction information of a particular user for analysis. The IA engine may select a particular user's information to analyze based on past analyses, volume of transaction data accrued for that user, user profile, number of ecoupons selected for use by the user, and so on.

The platform 120 may track and analyze user transaction history across various stores, as well as various locations of each store. The platform 120 can also track user transaction history or behavior across different mediums. The IA engine can analyze the transaction history to determine user behavior such as store preferences, geographical boundaries and activity hotspots, frequency and time of store visits, quantity of items purchased, whether a purchase coincides with an instore or other promotion, occurrence of coupon stacking, spending amount and trends, purchase of related goods or services in the same or another transaction, the payment mode, the level of ecoupon usage relative to each store visit.

In some embodiments, one or more servers of the ecoupon platform analyzes behavior of the specific user at the UPC level to identify purchases of related goods or servers in transactions of the specific user. In some embodiments, one or more servers of the ecoupon platform analyzes behavior of the specific user at the UPC level to identify quantity of items purchased in the transaction of the specific user. In some embodiments, one or more servers of the ecoupon platform analyzes behavior of the specific user at the UPC level to identify one of time or frequency of visits to the one or more stores corresponding to the transactions of the specific user. In some embodiments, one or more servers of the ecoupon platform analyzes behavior of the specific user at the UPC level to identify items purchased in connection with a promotion.

The platform may analyze user behavior at the UPC or transaction level. The IA engine 219 may parse, filter, organize or otherwise process a user's transaction information into personalized information that reflect the transaction behavior for the user. The ecoupon platform may store the personalized information in the platform database 250. Such personalized information may include shopping habits, preferences and other characteristic. The IA engine may create a user profile from the personalized information. Based on the user's transaction history, behavior and/or personalized information, the IA engine may determine or infer user preferences for incorporation into the user profile. For example, the IA engine may determine, infer or predict products, services, stores or brands that a user may like or need. The IA engine may determine user-specific information such as estimated spending power, lifestyle preferences, level of brand loyalty and shopping habits, for incorporation into a corresponding user profile. The platform 120 may incorporate user identification information, such as the user's name, age, address or other identifier into the user profile.

Referring to step 360, and in some embodiments, the IA engine may update a user's profile based on the analysis. In some embodiments, the IA engine creates or generates a user profile based on the analysis. For example, the IA engine may determine that the analysis provided sufficient information to establish a user profile. The platform 120 may store the user profile in the platform database 250. In some embodiments, the IA engine may determine that a user profile exists, which may be incomplete or not up-to-date. The IA engine may access the platform database 250 to determine if a specific user's profile already exists. The IA engine may update or replace an existing user profile based on the analysis. The server of the ecoupon platform may update the user profile to identify the specific user's preferences based on the analysis

In further details of step 365, the ecoupon platform may identify one of the plurality of users interacting with a medium. The medium may comprise an online medium, such as a web-site, application, mobile application, interactive television services, such as a smart TV, etc. The ecoupon platform may identify a user in real time, e.g., as the user is interacting with the medium. The ecoupon platform may identify a user interacting with a medium based on an identifier and/or user profile of the user. In some embodiments, a user may carry a mobile device installed with an ecoupon agent or app. The ecoupon app may detect that the user is in a store or business location. The ecoupon app may detect that the user is in the vicinity of a store or business. The ecoupon app may communicate with the platform and identify the user to the platform. The ecoupon app may further provide the location and store/business information to the platform.

In some embodiments, a service provider (e.g., for cable, TV, satellite, web, cellular, and internet, web or application, Software As A Service (SaaS), Platform As a Service (PaaA), Infrastructure as a Service (IaaS), etc.) may communicate with the ecoupon platform to identify a user when the user is interacting with a respective medium. In some embodiments, the server(s) of the ecoupon platform may receive identification of the specific user from an online service provider, which provides the online medium via which the user is interacting. The ecoupon platform or a server thereof may identify a specific user via a cookie. In some embodiments, the platform may distribute user profile information to various mediums via their service providers. Based on the user profile information, a service provider and/or the platform 120 may detect a user interacting with a corresponding medium. For example, a user may be identified by a cable service provider when the user's cable/satellite set top box is powered up. The service provider may convey the identity of the user to the platform 120 to match against user information stored in the platform database 250. In certain embodiments, the service provider may have access to user profiles, and can identify a user to the platform 120 based on a comparison against the profiles. In some embodiments, the service provider may identify a particular user to be an ecoupon user based on previous interactions. The service provider may provide information about a program or content that the user is watching or has ordered (e.g., via video-on-demand) to the platform.

In one non-limiting example of an online medium and/or service provider, an internet service provider (ISP) may identify a user that logins to a network accessed via the ISP. The ISP may identify the user to the platform 120. In some embodiments, the platform and/or the ISP encodes, tags or embeds an identifier of the user in a tracking cookie (sometimes referred to as an ecoupon cookie). In one embodiment, the platform may tag the user's identifier in a cookie when the user navigates from a portal 210 of the platform. As the user navigates online, a web content provider may detect the cookie and may parse the cookie for information. The content provider may identify the user based on an identifier or other information stored on the cookie. In some embodiments, the cookie may include instructions for a content provider to communicate with the platform. The content provider and/or the ISP may communicate with the platform to identify and track the user as the user navigates across web pages. The ISP and/or content provider may further convey information about the content of a webpage that the user may be exposed to.

Referring to step 370, and in some embodiments, the ecoupon platform may identify an electronic coupon campaign, such as a campaign based on the identified user's profile and/or user's purchase history (Step 370). Based on the identification of the user interacting with a medium, the ecoupon platform may access the platform database 250. The ecoupon platform may access the identified user's profile and/or personalized information from the platform database 250. The platform may identify the user's past purchases, such as past UPC level purchases. The platform may identify user preferences and other characteristics based on the user's profile and/or personalized information. In some embodiments, the platform may identify existing ecoupon campaigns for matching against the user's profile and/or personalized information. The platform may identify one or more ecoupon campaigns compatible with the user's profile and/or personalized information. The platform may identify one or more suitable ecoupon campaigns based at least in part on the information provided by the content and/or service providers. The platform may identify one or more suitable ecoupon campaigns based at least in part on the medium. The platform may identify one or more suitable ecoupon campaigns based at least in part on the web content or program that the user being exposed to. The platform may identify one or more suitable ecoupon campaigns based at least in part on a purchase or transaction history of the user

The ecoupon campaigns may be identified as providing ecoupons that the user may likely be interested in. For example, the platform may determine that the user has previously purchased the same or a similar product. The platform may determine that the user has previously used or redeemed the same or a similar ecoupon. The platform may determine that the user has previously demonstrated brand loyalty to the sponsor of a particular ecoupon campaign. The platform may identify that the user has selected an ecoupon that can be used in the store that he user is currently located in or near to, but has not been used or redeemed by the user.

In some embodiments, such as in an online context, the platform 120 may perform a cookie swap with an ad exchange. The ad exchange may assign a tracking cookie to track the online activities of an identified user, for example, which advertising impressions have been presented to the user and/or which ads the user has interacted with (e.g., click, mouse-over). An ecoupon cookie assigned to the user may identify the user and/or include a portion of the user's profile. The ad exchange may determine, based on the ecoupon cookie, that a particular ad campaign fits the profile and/or preferences of the user. The platform 120 may determine, based on the tracking cookie, that a particular ecoupon campaign may be suitable for targeting the user. In some embodiments, the platform may deliver an ecoupon for the campaign to a specific user via the online medium. In some embodiments, the platform and/or the ad exchange may collaborate to serve ads and/or ecoupons to the user. In certain embodiments, the ad and ecoupon campaign are part of the same marketing campaign. For example, an ad may be served to the user to promote a product and may offer an associated ecoupon for download or selection. The platform may also send an ecoupon to the user. For example, the ecoupon may be transmitted to the user's mobile device app.

In further details of step 375, and in some embodiments, the ecoupon platform may deliver an electronic coupon from the identified campaign to the identified user. The identified ecoupon campaign may feature one or more ecoupons. In certain embodiments, the ecoupon platform may deliver an ecoupon to the identified user via the same medium. The ecoupon platform may deliver an ecoupon via a suitable and perhaps different medium, e.g., via a mobile device app when the user is physically located in a store. The ecoupon may also be delivered or transmitted via any suitable means, such as via email or IM. As further examples, an ecoupon may be delivered to the user's social network webpage (e.g., in Facebook), to the user's ecoupon account, or via the user's mobile device app.

In some embodiments, the platform, ad exchange and/or service provider delivers an ad from the identified ad campaign to the user. The ad may be delivered in place of, or in addition to an ecoupon. In some embodiments, the ad includes an ecoupon, or provides an option to download the ecoupon. The platform, ad exchange and/or service provider may interact to implement a coordinated and/or personalized marketing effort to promote one or more products and/or services to the identified user based on the user's profile. For example, the cable service provider may deliver a customized ad to the TV display of the user during a commercial time segment. A web content provider may stream a video or flash segment to a browser or mobile app of the user, for example, while content is downloading. Accordingly, a user may be identified for targeted or individualized marketing or rewards, e.g., based on the user's profile.

D. Viral Marketing, Tracking and Rewarding of UPC Level Electronic Coupons

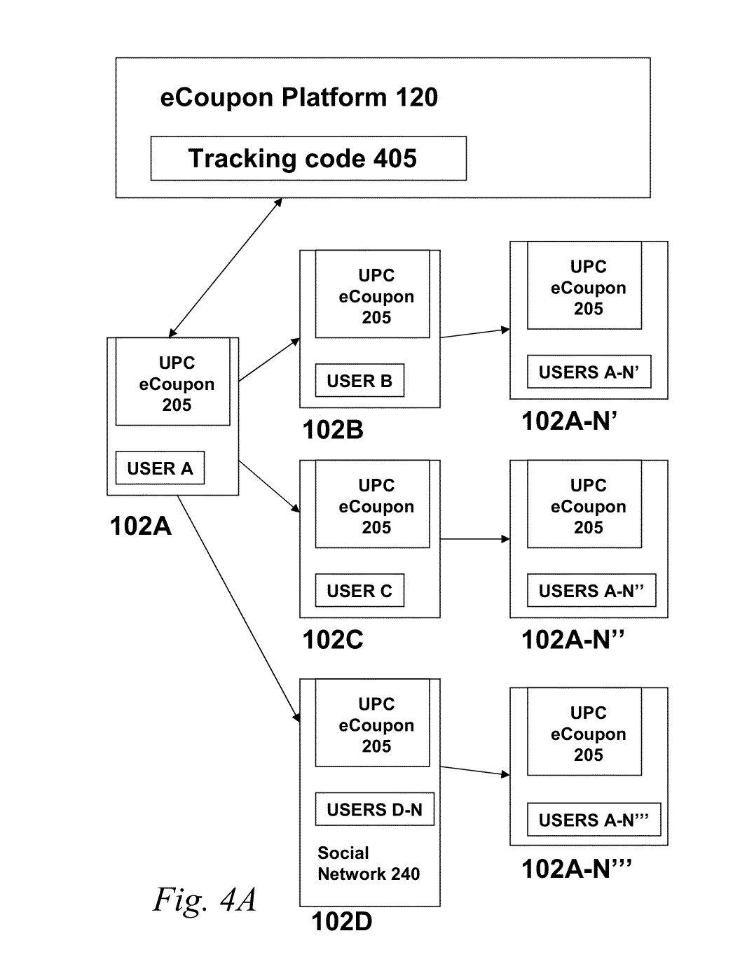

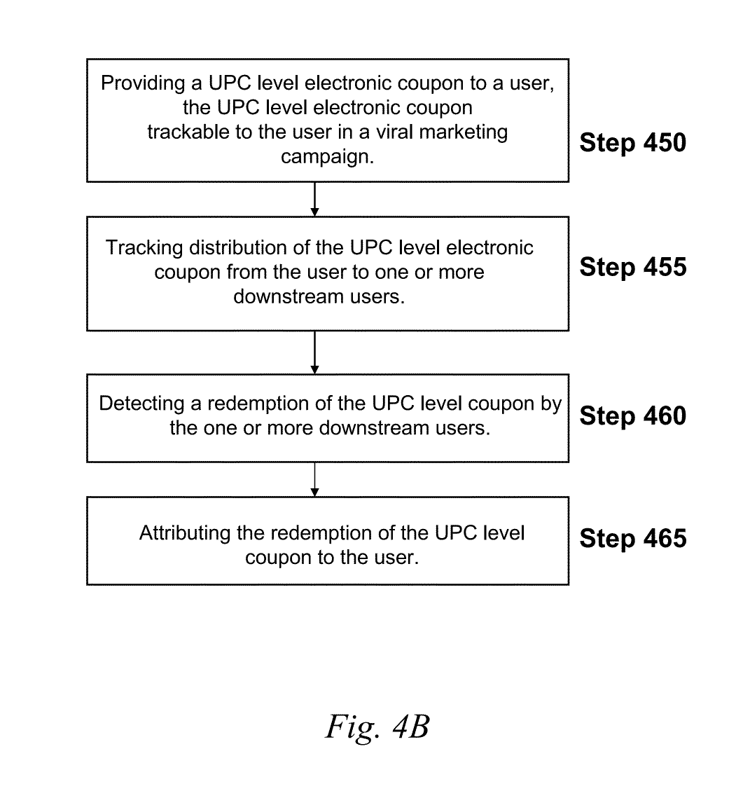

Referring now to FIGS. 4A and 4B, systems and methods for viral marketing, tracking and rewarding of electronic coupons distributed across a plurality of different users and/or a plurality of different mediums. The ecoupon platform may generate tracking codes unique to each user. The tracking code is used for tracking electronic coupons, such as Universal Product Code (UPC) based electronic coupons, distributed by each user. The tracking code may be embedded into an electronic coupon offered to a user. The ecoupon platform form may track redemption of the electronic coupon by a other users who receive r the electronic coupon from the user. Via the tracking code, the ecoupon platform may identify the user via redemption of electronic coupons from other users and responsive to the identification, provide an attribution of the redemption of the electronic coupon, by the other user, to the user.

Referring to FIG. 4A, one embodiment of a system for implementing viral marketing, tracking and rewarding of UPC level ecoupons is depicted. In brief overview, the system includes an ecoupon platform 120 which embeds a tracking code 405 in a UPC ecoupon 205 for distribution from one user (e.g., user A) to one or more downstream users (e.g., user B, C, D-N, etc). The present system facilitates viral affiliate and multi-level ecoupon marketing, tracking and rewards. By allowing users to download a trackable ecoupon, and encouraging the distribution of the ecoupon, the platform can track the distribution and/or redemption of the ecoupon by any number of downstream users. A rewards program may incentivize a user to distribute an ecoupon by attributing a downstream redemption back to the user. The attribution may include contributing a portion of the redeemable value from the ecoupon, or any other benefit, to an originating user.

In further details, the ecoupon platform may generate a tracking code for an ecoupon offered to a user. In some embodiments, a tracking code is generated when the ecoupon is linked to a user, e.g., via the user's ecoupon account or the user's mobile device app. Such a user may be referred to as an originating user. In certain embodiments, the ecoupon includes executable code that generates the tracking code when the originating user distributes, shares or transmits the ecoupon to another user. In other embodiments, the ecoupon generator 215, tracking/management module 220 and/or ecoupon viral marketing module 230 of may generate the tracking code, and may embed the tracking code into the ecoupon.

Each tracking code may be unique to a corresponding originating user. In some embodiments, the tracking code includes an identifier of the originating user. The tracking code 405 may comprise any type or form of tracking cookie, uniform resource locator (URL), watermark, digital signature, code, tag, pixel or image. By way of illustration, an identifier of the originating user may embedded in a URL, or encoded into a digital image on the ecoupon. In some embodiments, the tracking code may include program code that extracts the identity of intermediate users along any chain of distribution. For example, the program code may self-execute when a user receives the ecoupon from the originating user. The program code may execute on the device (e.g., 102B, 102C) operated by the receiving user (e.g., user B, C). In some embodiments, the program may execute when the receiving user accepts the ecoupon (e.g., into the receiving user's ecoupon account, or via the receiving user's ecoupon app). Upon execution, the program may embed the identity of the receiving user into the ecoupon. In certain embodiments, the program code executes when a receiving user sends the ecoupon to another user.

In some embodiments, the tracking code tracks the identity of the originating user, and/or some or all of the intermediate users. In certain embodiments, the tracking code only tracks the originating user. In other embodiments, the tracking code tracks a limited number of users in a distribution chain. In some embodiments, the platform may store an identifier of the originating user in the ecoupon account of a receiving user. The platform may also store an identifier of a preceding user to the receiving user's ecoupon account. Such tracking mechanisms can allow the platform to perform viral affiliate tracking and attribution.

Responsive to a redemption of the ecoupon by one of the downstream users, the platform may determine the originating user of the ecoupon. The platform 120 may determine one or more intermediate users in the distribution chain. In one embodiment, the platform determines the immediately preceding user, from which the ecoupon is obtained and later redeemed. The platform may determine the originating user and/or any number of preceding or intermediate user(s) based on the tracking code of the redeemed ecoupon. The platform may identify the originating user and/or any number of preceding or intermediate user(s) based on a record of user identifier(s) stored in the account corresponding to the redeemed ecoupon.

The platform may attribute the redemption to the originating user, and/or one or more of the intermediate users. In attributing the redemption, the platform may assign or allocate a portion of the redeemable value to any one or more of these users. For example, the originating user may receive a predetermined portion (e.g., 50% or 20%) of the redeemable value. The user redeeming the ecoupon may still receive 100% of the redeemable value. In certain embodiments, the redeeming user is only allocated a portion of the redeemable value. In some embodiments, the immediately preceding user receives a predetermined portion (e.g., 10% or 25%) of the redeemable value. Intermediate users may or may not receive any value in some embodiments, and may depend on the ecoupon type and campaign.

In some embodiments, the incentive for distributing ecoupon may be in the form of other types of rewards or benefits. For example, the originating user may be able to redeem his/her own ecoupon at twice the redeemable value. The originating user may be able to accrue rewards or points for every downstream user that accepts and/or redeems the ecoupon. The originating user may accrue rewards or points for every new downstream user that signs up for an ecoupon account. The originating user may accrue rewards such as airline miles, gift or dining vouchers, movie tickets, etc. In some embodiments, attribution or rewards are determined based on successful redemption, which may exclude coupon stacking, redemption past the validity period, and any type of fraud, for example.

A user may distribute, send or share an ecoupon via any means. For example, an ecoupon may be distributed or shared using social media (e.g., posting or sharing on Facebook, Twitter, discussion boards), email, instant messaging, inter-device communications (e.g., Bluetooth transmissions between cell phones), mobile device app enabled sharing, and so on. An email, instant message or posting (e.g., discussion/bulletin board, or webpage/blog posting) may include a link or URL to the ecoupon embedded with the tracking code. A user may identify a friend via an ecoupon app or the ecoupon user account, with which to share the ecoupon.

By tracking viral behavior of an ecoupon via specific users, the ecoupon platform may be able to identify effective channels for ecoupon or ad campaigns. Campaign sponsors may also be able to gain insight and analytics for tailoring or expanding marketing campaigns, for example to complementary mediums. By tracking the distribution of a specific ecoupon through existing and new user accounts over a period of time for example, the platform may be able to determine the viral reach of a given user or viral affiliate. The platform may be able to assess the suitability of particular viral affiliate in spreading a specific type or category of ecoupon. The platform may be able to assess the suitability of a specific type of incentive offered. A campaign sponsor may design a test campaign to assess the reach and/or effectiveness of particular channels (e.g., types of viral affiliates). The platform may use such viral marketing techniques to expand the ecoupon user base and/or create publicity and awareness.

In some embodiments, the platform may track the effectiveness of different modes of transmission (e.g., email, social media), e.g., leading to a successful account sign-up and/or redemption. The platform may track the cost and benefits of various methods of attribution or rewards to find suitable incentives to drive results. In some embodiments, distribution of ecoupons may translates to more awareness and sales in a product, even though not every recipient may sign up to link and redeem the ecoupon. Based on the rate of distribution and redemption, the platform may determine an appropriate time period during which an ecoupon is valid. Based on the rate of distribution and redemption, the platform may determine what cap control limits to set.

Illustrated in FIG. 4B is an embodiment of a method for implementing viral marketing, tracking and rewarding of UPC level ecoupons. In one embodiment, an ecoupon platform provides a UPC level electronic coupon to a user (Step 450). The UPC level electronic coupon may be trackable to the user in a viral marketing campaign. The ecoupon platform may track distribution of the UPC level electronic coupon from the user to one or more downstream users (Step 455). The ecoupon platform may detect a redemption of the UPC level coupon by the one or more downstream users (Step 460). The ecoupon platform may attribute the redemption of the UPC level coupon to the user (Step 465).

Referring to step 450, and in some embodiments, an ecoupon platform provides a UPC level electronic coupon to a user. The ecoupon platform may generate and/or offer an ecoupon to a user. The platform may generate a tracking code that is associated with or identifies the user. The platform may insert, embed or otherwise modify the ecoupon to include the user's tracking code. The platform 120 offer the ecoupon to a user for distribution to other individuals. In some embodiment, the platform may offer an incentive for the user (originating user) to distribute the ecoupon to other users. The platform may offer any type of incentive, such as airline miles, a portion of the redeemable value of the ecoupon if redeemed by a downstream user, gift vouchers, bonus reward points, and so on. The platform may offer an incentive for a user receiving the ecoupon to further distribute the ecoupon to other users. In certain embodiments, the platform identifies one or more originating users (e.g., based on their user profiles) to distribute an ecoupon. The platform may identify the one or more originating users as belonging to a consumer segment likely to be interested in using and/or sharing the ecoupon.

The UPC level electronic coupon may be trackable to the user in a viral marketing campaign. The platform may generate and/or embed a tracking code in the ecoupon prior to distribution. For example, the platform may generate the tracking code when an originating user accepts or attempts to send the ecoupon to one or more users. In some embodiments, the platform generates the ecoupon to include program code that executes when the ecoupon is shared with another user or accepted by another user. The program code may identify and/or maintain a record of one or more users receiving the ecoupon along a chain of distribution. The platform may generate the tracking code to comprise a tracking cookie, an identifier or tag of the originating user, a watermark, a digital signature, an image, a pixel, and so on.

In further details of step 455, the platform may track distribution of the UPC level electronic coupon from the user to one or more downstream users. The platform may track distribution of the ecoupon from the originating user to a group of users, and from the group of users to a second group of users. The platform may track distribution of the ecoupon over multiple levels of distribution. In some embodiments, the tracking code in the ecoupon identifies the originating user and/or one or more intermediate users along a chain of distribution. In some embodiments, the platform records the originating user and/or a preceding user in a receiving user's ecoupon account. Thus, once the receiving user redeems the coupon, the platform may identify the originating user and/or the preceding user by accessing this record. The platform may identify and track the medium (e.g., online medium (web-site, social networking, etc). by which the downstream user received, accepted, used and/or redeemed the electronic coupon.

In some embodiments, when a user accepts an ecoupon from another user, the tracking code in the ecoupon may record the identity of the preceding user. In some embodiments, the tracking code may update a receiving user's ecoupon account to identify the originating user of a received ecoupon. The tracking code may update the chain of preceding users in the received ecoupon and/or the receiving user's ecoupon account. In some embodiments, the distributed ecoupon is trackable to the originating user because the ecoupon is embedded or encoded with an identifier of the originating user.

A user may share an ecoupon with another user using various means, including but not limited to email, instant messaging, sharing through social media, posting an ecoupon on a website, blog or discussion board, communicating the ecoupon from an ecoupon app to another user's ecoupon app, wireless transmission of an ecoupon from a first device to another user's device, and sharing or recommending the ecoupon to acquaintances via ecoupon accounts. For example, a user may embed a link or URL of the ecoupon in a message transmitted to a second user. A user receiving an invitation to accept an ecoupon may register or link the ecoupon to the receiving user's ecoupon account. In some embodiments, a new user receiving an ecoupon may register for or create a new ecoupon account. The tracking code may, in certain embodiments, record the mode(s) of distribution in the received ecoupon and/or the receiving user's ecoupon account. Thus, the platform may determine various modes of distribution recorded in each ecoupon.

Referring to step 460, and in some embodiments, the ecoupon platform may detect a redemption of the UPC level coupon by the one or more downstream users. A server of the ecoupon platform may receive a redemption or request for redemption of the electronic coupon by a downstream user who received the ecoupon from the user to which the ecoupon platform offered the ecoupon. A server of the ecoupon platform may receive an acceptance or request for acceptance of the electronic coupon by a downstream user who received the ecoupon from the user to which the ecoupon platform offered the ecoupon. The downstream user may have received the ecoupon from any one of a plurality of modes of distribution from the user or another downstream user. The ecoupon platform may detect, receive or process a redemption based on any embodiment of the methods and features described above in connection with FIGS. 2, 3A and 3B. Upon detecting, receiving or processing a redemption by a downstream user, the platform may parse, decode or process the ecoupon to identify the originating user and/or preceding user(s). In some embodiments, the platform may access a record of the ecoupon account within which the ecoupon was redeemed, to determine the originating user and/or preceding user(s). The ecoupon platform may identify from the redemption of the electronic coupon, a mode of distribution of the electronic coupon from one user to another user, such as the user offered the ecoupon initially to the user redeeming the ecoupon. The ecoupon platform may identify and track via redemptions of the electronic coupon by a plurality of downstream users, distribution of the electronic coupon by the user via a plurality of modes of distribution to the plurality of downstream users. The ecoupon platform may analyze, one or more of the following for the electronic coupon: rate of distribution, rate of redemption and mode(s) of distribution.

In some embodiments, the platform may determine if the redemption is valid. For example, the platform may determine if the transaction for the redemption was completed within a specified validity period of the ecoupon. The platform may determine if any event such as coupon stacking, concurrent promotions, purchase quantity restriction, repeat usage of ecoupon and ecoupon cap control may invalidate a redemption. The platform may determine if the redemption fails to meet any of ecoupon's redemption requirements or conditions. The platform may determine if the ecoupon redemption is fraudulent or defective in any way.

In further details of step 465, the ecoupon platform may attribute the redemption of the UPC level ecoupon to the originating user. The ecoupon platform may attribute the redemption of the ecoupon to the originating user responsive to validating the redemption of a downstream or other user. In some embodiments, the ecoupon platform may attribute the redemption of the ecoupon to one or more preceding users along a chain of distribution. By attributing the redemption to a user, the platform may provide that user with a portion of the redeemable value of the ecoupon. The platform may provide the user redeeming the ecoupon with 100% of the redeemable value. In some embodiments, the platform may allocate a user redeeming the ecoupon with a portion of the redeemable value, for example, the reminder of the redeemable value after subtracting allocations to preceding user(s). In some embodiments, the platform may provide other forms of incentives or rewards based on the redemption of a distributed ecoupon, for example, those described above in connection with FIG. 4A.

The platform or ecoupon campaign sponsor may analyze distribution modes, distribution patterns, distribution rates, as well as the redemption rate of an ecoupon. The platform may be able to assess the effectiveness of offered incentives (e.g., rebates, portion of redeemable value or gift voucher) and viral affiliates, and may accordingly update or fine-tune a marketing campaign. In some embodiments, the platform may identify a consumer segment that provides effective viral affiliates for a particular type of ecoupons. The platform may also track the distribution and redemption rates of an ecoupon to determine a suitable validity period for the ecoupon.

E. Aggregate Cap Control of UPC Level Electronic Coupons Across Different Mediums

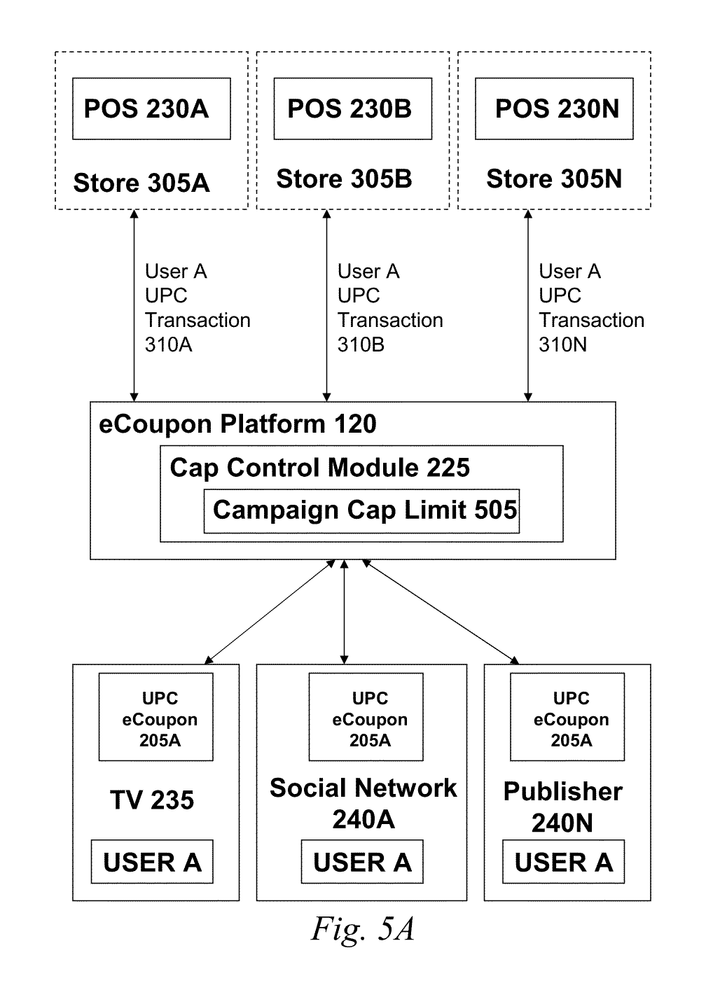

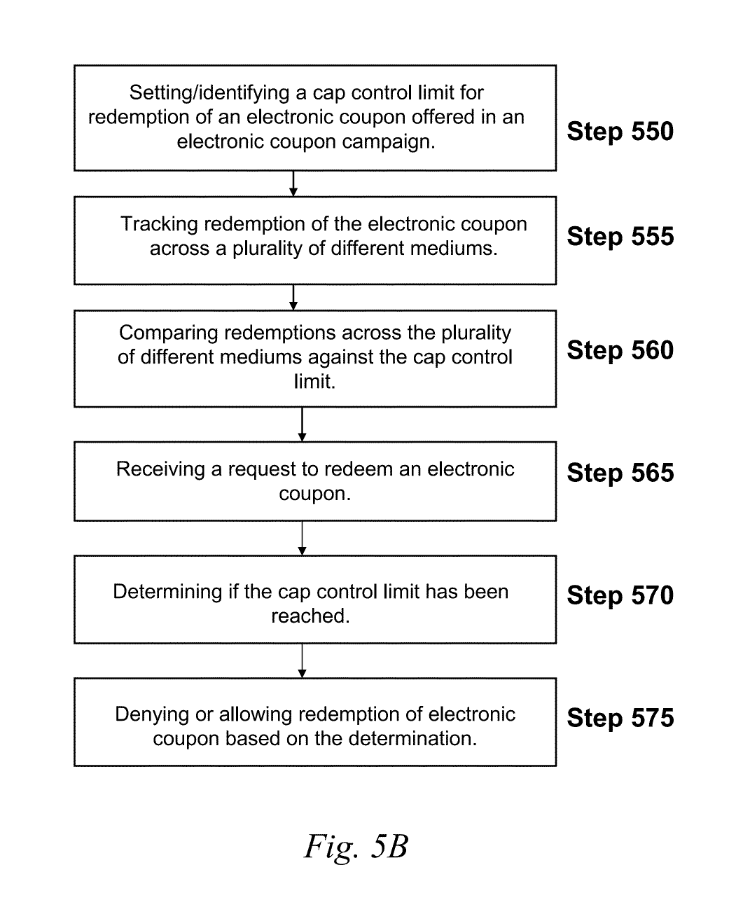

Referring now to FIGS. 5A and 5B, systems and methods for providing aggregate cap control management of UPC level electronic coupons provided across different mediums will be described. Embodiments of the present solution provides cap control tracking and management for electronic coupons, such as UPC based ecoupons, across a plurality of different mediums and across a plurality of users, such as via any embodiments of the viral distribution of ecoupon described herein. With this cap control management, redemptions of ecoupon campaigns can be tracked, managed and controlled or limited even though the ecoupons may be distributed and redeemed across different mediums and different users.

Referring to FIG. 5A, one embodiment of a system for implementing aggregate cap control of UPC level electronic coupons across different mediums is depicted. In brief overview, the system includes an ecoupon platform having a cap control module 225 that sets a cap limit 505 for coupon distribution or redemption. This system may include any embodiment of features described above in connection with FIGS. 2, 3A, 3B, 4A and 4B. The ecoupon platform may track the distribution and use of ecoupons across a plurality of mediums including offline instore redemptions, online redemptions, TV-related shopping, mobile apps, social networking sites and social media.

The ecoupon platform may include a cap control module 225. The cap control module 225 may be built and configured for setting and/or controlling the number of ecoupons that can be used across one or more mediums. The cap control module 225 may be implemented in hardware or a combination of hardware and software. The cap control module 225 may include any script, program, agent or component executing on one or more processors or cores of the ecoupon platform 120. An ecoupon campaign sponsor may set or determine a cap limit for an ecoupon campaign via the cap control module 255. For example, the ecoupon platform may provide an interface/portal 210 for a campaign sponsor or administrator to access features of the cap control module 225.

The cap control module 255 may calculate, identify, determine, set or configure a cap limit 505 for an ecoupon campaign. This cap limit 505 may determine the number of ecoupons that can be redeemed, for example, during the ecoupon campaign period or a validity period specified by the ecoupon. In some embodiments, a cap limit 505 is set for the frequency of redemption, such as the number of redemptions per day, week or other time period. The cap control module may set a cap limit 505 for the number or frequency of redemptions allowed within a particular context, such as within a specific medium, store, store location, geographical location, user, transaction, or specified by other parameters. Thus, a cap limit can be specified according to any combination of parameters defining a context, which may include a time period and/or frequency limits. Moreover, a plurality of cap limits may be specified based on different contexts.

The cap control module 255 may determine or specify a cap limit based on a campaign budget. The campaign sponsor may specify a lump sum campaign budget, or may include allocations for particular consumer segments, targeted mediums, stores, geographical locations, and so on. The cap control module may determine one or more cap limits based on the specified budget. In some instances, the cap control module may calculate an aggregate cap limit, which may be the campaign budget divided by the redeemable value of each ecoupon. In some embodiments, an ecoupon campaign may include ecoupons of different redeemable values. For example and in one embodiment, a campaign may feature separate types of ecoupons with different redeemable values for purchasing different quantities of the same product. In another embodiment, the same ecoupon may specify different redeemable values for purchasing different quantities of the same product.

In some embodiments, the cap control module may determine the allocation of the budget and/or cap limits based one or a combination of the following factors: campaign budget, other input from the sponsor (e.g., types of ecoupons, redeemable value, targeted consumer segments), specified context(s), time and frequency limits, use of viral affiliate marketing, and so on. The cap control module may determine the allocation of the budget and/or cap limits based on information and/or analysis contributed by one or more of: the ecoupon manager 220, the viral marketing engine 230, the IA engine 219, the platform database 250. In some embodiments, the IA engine 219 provides consumer segment and/or user-level insights, and may communicate with third party providers such as BlueKai to provide recommendations for budget allocations (e.g., across mediums and/or market/consumer segments). The viral marketing engine 230 may identify viral affiliates and/or analyze for distribution patterns and rates, which may be used for determining cap limits and/or budget allocations (which may include incentives for viral affiliates). In some embodiments, the ecoupon platform may design and/or conduct test campaigns. Based on the results of one or more test campaigns, the cap control module 225 may determine or recommend one or more budgeting and/or cap limit options.

In some embodiments, a campaign sponsor may impose or specify a cap limit based on achieving a certain target, for example, a sales target in a featured product, a target level of awareness of the featured product, and so on. The cap control module, alone or in conjunction with any other platform modules (e.g., tracking/management module 220, viral marketing engine 230, IA engine 219) may monitor if the target is met. The cap control module may adjust the allowable period for redemption of new ecoupons. The cap control module (e.g., in communication with the ecoupon manager 220) may expire an ecoupon and/or reduce the circulation of the ecoupon, for example, when certain target are met. In some embodiments, the platform 120 may alert a user trying to download or share an ecoupon that the ecoupon is expiring or is not longer available.

In some embodiments, the cap control module may inform users that have selected the ecoupon of an impending expiration of the ecoupon. The cap control module (e.g., in communication with the ecoupon manager 220) may update users linked with the ecoupon that a cap limit is almost reached. For example, the ecoupon may include a count-down or tracking feature that indicates the number of completed redemptions against a cap limit, or the number of redemptions remaining The ecoupon may, in some embodiments, include a feature that counts-down to an expiration date, or warns a user of an impending expiration. Such features may encourage a user to use the ecoupon while redemptions are still available.

In some embodiments, the cap control module 225 may limit the number of ecoupons distributed. The cap control module may subject ecoupon distribution to a distribution cap limit. For example, the cap control module 225 may limit the number of ecoupons that users can download or link to the users' ecoupon accounts. Once the cap limit is reached, the cap control module (e.g., in communication with the ecoupon manager 220) may disallow additional users to download or select the ecoupon. The cap control module 225 may allow existing ecoupons (e.g., downloaded or linked to the users' ecoupon accounts) to be redeemed, for example, subject to the ecoupon's validity period.

The platform 120 may track distribution and/or redemption of an ecoupon against one or more cap limits. The ecoupon platform can allow tracking of ecoupon usage and distribution across multiple users, retailers, geographical locations, distribution modes (e.g., email, social networks) and mediums. The ecoupon platform may allow a campaign sponsor to design or update an ecoupon campaign by granular tracking of ecoupon downloads and/or redemption. The ecoupon platform can re-allocate various cap control limits, for example, between weaker and more effective consumer segments or mediums. The platform 120 may track distribution and/or redemption of an ecoupon in real time or substantially in real time.

In some embodiments, there is a lag period (e.g., 1-7 days) for tracking or processing redemptions. For example, a store or rewards program administrator may deliver transaction information to the ecoupon platform on a weekly basis. Thereupon, the platform may validate a transaction against the ecoupon and recognize a redemption. Thus, a redemption may be recognized some period of time after the transaction has occurred. And during this time period, a user may assume that the ecoupon can be successfully redeemed. The platform may implement certain solutions to address such situations. In some of these embodiments, the cap control module may set milestone limits to take into consideration the time for processing a redemption. A milestone limit for distribution and/or redemption may be set relative to a cap limit. For example, a milestone limit may be set at 10% less than a corresponding cap limit. The cap control module may stop or limit distribution of an ecoupon when a milestone limit is met, so that the final number of eventual redemptions may be close to the cap limit. In some embodiments, the platform may recognize redemptions in transactions occurring up to the point when a cap limit is met, even though recognizing such redemptions causes the cap limit to be exceeded. In some other embodiments, the cap control module may disallow further redemptions once a cap limit is met.

Illustrated in FIG. 5B is an embodiment of a method for implementing aggregate cap control of UPC level electronic coupons across different mediums. In one embodiment, an ecoupon platform sets or identifies a cap control limit for redemption of an electronic coupon offered in an electronic coupon campaign (Step 550). The ecoupon platform may track redemption of the electronic coupon across a plurality of different mediums (Step 555). The ecoupon platform may compare redemptions across the plurality of different mediums against the cap control limit (Step 560). The ecoupon platform may receive a request to redeem an electronic coupon (Step 565). The ecoupon platform may determine if the cap control limit has been reached (Step 570). The ecoupon platform may deny or allow redemption of electronic coupon based on the determination (Step 575).

Referring to step 550, and in some embodiments, an ecoupon platform sets or identifies a cap control limit for redemption of an electronic coupon offered in an electronic coupon campaign (Step 550). The platform may set, determine or identify a cap control limit via a cap control module 225. The platform may set, determine or identify a cap control limited for an ecoupon campaign across all different mediums or modes of distribution. The platform may set, determine or identify a cap control limit for an ecoupon campaign across each medium or mode of distribution. The platform may set, determine or identify a cap control limit for an ecoupon campaign for each user across different mediums or modes of distributions. The platform may set, determine or identify a cap control limit for an ecoupon campaign for a group of users across different mediums or modes of distributions. The platform may set, determine or identify a cap control limit for any combination of users, mediums or modes of distribution.

The cap control module may set, determine or identify one or more cap limits based on one or more context parameters, for one or more contexts. The cap control module may set, determine or identify one or more milestone limits in relation to corresponding cap limits. The cap control module may set a milestone limit based on various factors such as the distribution and/or redemption rate, trend, redemption processing period, and so on. The cap control module may set, determine or identify one or more cap limits based on a budget or budget allocation of an ecoupon campaign sponsor. The cap control module may set, determine or identify one or more cap limits based on distribution rate, redemption rate and/or redemption processing period. The cap control module may recommend a cap limit based on any one or more of: information provided by other platform modules, specified budget, consumer segment or individual level insights and analytics, information from third party providers, test campaigns, viral affiliate data, and so on.

In further details of step 555, the ecoupon platform may track redemption of the electronic coupon across a plurality of different mediums. The ecoupon platform may track a number of completed redemptions of an ecoupon for a campaign across each medium of the plurality of different mediums. The platform may track distribution and/or redemption of ecoupon within each medium, and may consolidate or aggregate the distribution and/or redemption statistics across one or more mediums. The platform 120 may track distribution and/or redemption of ecoupon via any means, such as using any embodiment of features and methods discussed above in connection with FIGS. 2, 3A, 3B, 4A, 4B and 5A.

Referring to step 560, and in some embodiments, the ecoupon platform may compare redemptions across the plurality of different mediums against the cap control limit

In certain embodiments, the cap control module compares the number of distributed ecoupons against a distribution cap limit. The platform may compare ecoupon redemptions and/or distribution against one or more cap limits and/or milestone limits. In some embodiments, the cap control module may inform users of an impending expiration of an ecoupon. The cap control module (e.g., in communication with the ecoupon manager 220) may update users that a cap limit is almost reached. The platform, cap control module and/or ecoupon may include a count-down or tracking feature that compares the number of completed redemptions to a cap limit, or the number of redemptions remaining that can be claimed. The platform, cap control module and/or ecoupon may include a feature that counts-down to an expiration date, or warns a user of an impending expiration date.

In some embodiments, a campaign sponsor may impose or specify a cap limit based on meeting a certain target, for example, a target sales level in a featured product. The cap control module, alone or in conjunction with any other platform modules (e.g., tracking/management module 220, viral marketing engine 230, IA engine 219) may monitor if such a target is met. The cap control module may adjust the available period for redemption of new ecoupons. The cap control module (e.g., in communication with the ecoupon manager 220) may expire an ecoupon and/or reduce the circulation of the ecoupon. In some embodiments, the platform 120 may inform a user trying to download or share an ecoupon that the ecoupon is expiring or is not longer available for use.

In further details of step 565, the ecoupon platform may receive a request to redeem an electronic coupon. The platform may receive a request to redeem or a redemption status of the Universal Product Code (UPC) based electronic coupon by a user of the plurality of different users via a medium of the plurality of different mediums and The platform may receive the request to redeem the Universal Product Code (UPC) based electronic coupon during a transaction for a product or service corresponding to the UPC. In some embodiments, the platform may receive the request to redeem the Universal Product Code (UPC) based electronic coupon after a transaction for a product or service corresponding to the UPC.

The platform may receive a redemption request in real time or substantially in real time during a qualified transaction. A POS system of a store (e.g., instore or online) may send the request to the platform, and/or send information regarding the transaction to the platform. The ecoupon platform (e.g., via an ecoupon manager 220) may match the transaction information against an ecoupon of a corresponding user. The ecoupon platform may identify the user using the transaction information (e.g., identified via affiliation to a rewards program), and may access the user's ecoupon account to validate the transaction information against the conditions of the ecoupon. In some embodiments, the platform may determine that certain conditions, such as the item specification, quantity, and validity period has been met in the transaction.

In some embodiments, the platform receives transaction information after a transaction has occurred. The platform may receive information from a plurality of transactions involving one or more users. The platform may parse or process the information according to the methods and systems discussed above, for example in connection with FIGS. 2, 3A and 3B. The ecoupon manager 220 of the platform may receive a request to redeem an ecoupon responsive to identifying a qualified transaction. The ecoupon manager may validate the transaction information against the ecoupon based on the request. The ecoupon manager may perform the validation process in accordance with some or all of the steps described above.

Referring to step 570, and in some embodiments, the ecoupon platform may determine if the cap control limit has been reached. The platform may determine whether or not the total number of completed redemptions has reached the cap limit. The platform may allow or deny the request to redeem based on the determination. The platform may increment a count of the number of redemptions responsive to the validation. In some embodiments, the platform may compare the count against a milestone limit, to determine if the milestone limit has been reached. In the absence of any context-specific cap control, the platform may compare the count against an aggregate cap limit for the ecoupon campaign. In some embodiments, the platform may determine that the request falls within one of a plurality of predetermined contexts. The cap control module may perform the comparison using a count of redemptions under that context, against a milestone or cap limit specific to that context.

In some embodiments, the cap control module may determine that the request falls within a plurality of different predetermined contexts. Each of these contexts may have a respective milestone or cap limit. The cap control module may determine a count of the number of redemptions in each context, for comparison against the corresponding context-specific milestone or cap limit. The cap control module may perform the comparison for the plurality of contexts sequentially or in parallel.

In further details of step 575, the ecoupon platform may deny or allow redemption of electronic coupon based on the determination (Step 575). The ecoupon platform may deny or allow redemption of electronic coupon based on a determination of whether a cap limit has been reached. In some embodiments, the cap control module may determine that a cap limit is not reached. Based on the determination, the cap control module may recognize or allow the redemption. In certain embodiments, the cap control module may determine that a cap limit is reached. Based on the determination, the cap control module may deny the redemption in certain embodiments. In some other embodiments, the cap control module may allow the present redemption, and may deny future redemptions (e.g., so that the cap limit is not exceeded). In certain embodiments, the cap control module may determine that a cap limit is exceeded. Based on the determination, the cap control module may deny the redemption.

The platform may determine that the total number of completed redemptions is within a predetermined threshold of the cap limit and responsive to the determination, updates one or more of the plurality of different users that the cap list is within the predetermined threshold of being reached. The platform may determine that the total number of completed redemptions has reached the cap limit and responsive to the determination, not redeeming the UPC based electronic coupon. The platform may determine that the total number of completed redemptions has not reached the cap limit and responsive to the determination, redeem the UPC based electronic coupon.

In some embodiments, the platform takes into consideration a time lag for receiving transaction information and processing redemption. In certain embodiments, the platform uses the milestone limit to address the time lag for receiving transaction information and processing redemption. For example, a milestone limit may be set at 10% less than a corresponding cap limit. The cap control module may stop or limit distribution of an ecoupon when a milestone limit is met, so that the final number of redemptions may be fall close to the cap limit. In some of these embodiments, the cap control module may recognize some or all ecoupons redeemed after the milestone limit is met. In some embodiments, the platform may recognize redemptions for transactions that occurred up to the point when a cap limit is met, even though recognizing such delayed redemptions causes the cap limit to be exceeded. In some other embodiments, the cap control module may disallow further redemptions once a cap limit is met.

F. Instant Reward and Real Time Processing based on Redemption of a UPC Level Digital Coupon

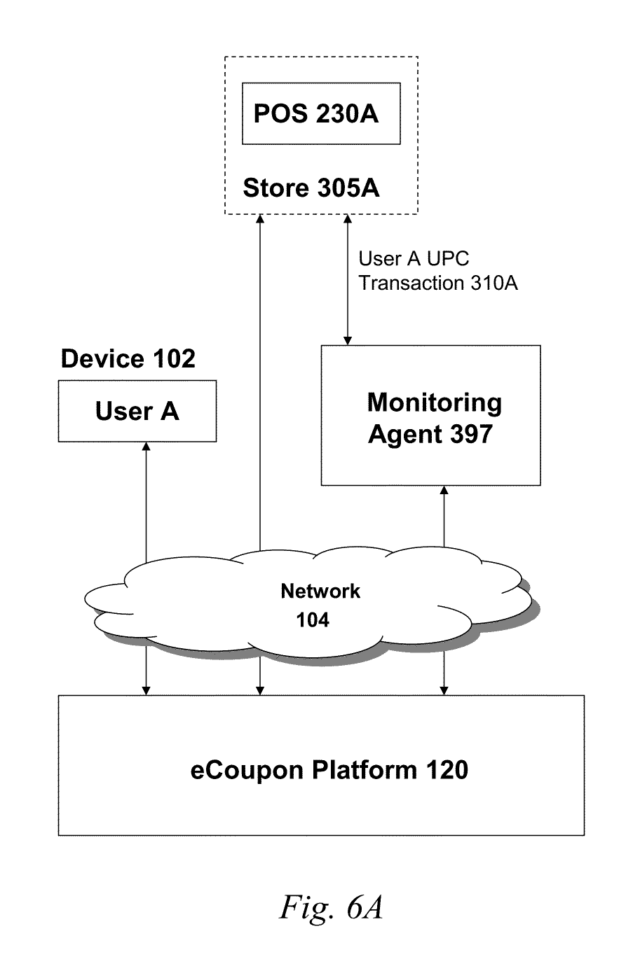

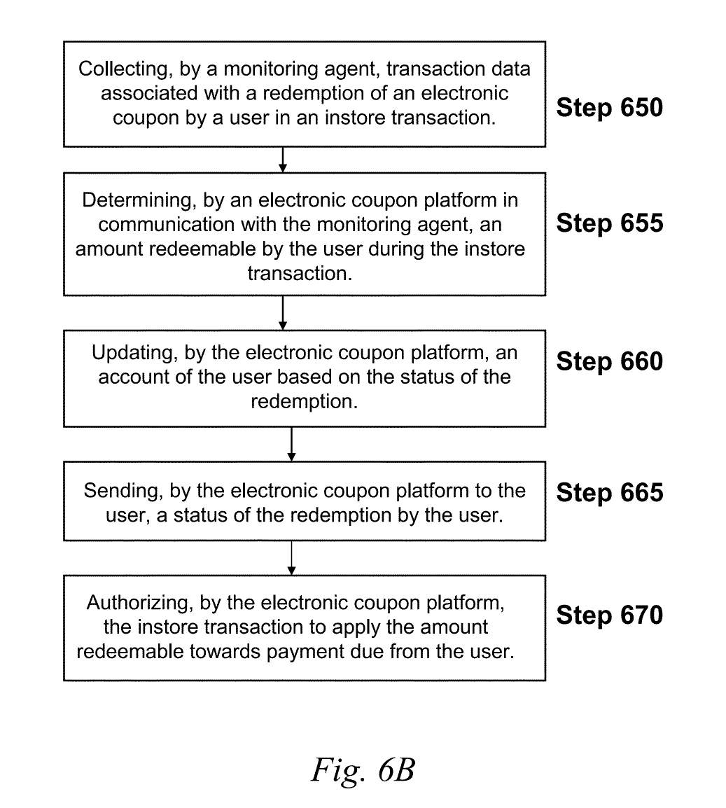

Referring to FIGS. 6A and 6B, systems and methods of a solution for real-time processing of redemption of UPC based ecoupons to provide instant rewards and electronic receipts incorporating the instant rewards will be described. In brief overview, the ecoupon platform may received via one or more networks, transaction information from a point of sale (POS) system as a transaction is being transacted for a user at the POS system. The ecoupon platform determines, based on the transaction information and while the transaction is being transacted, one or more electric coupons of the user to be redeemed via the platform based on the transaction. The ecoupon platform may transmit via one or more networks an electronic receipt to a device of the user, such as the user's phone, smart phone or mobile computing device. The electronic receipt identifying the transaction information from the POS system and the one or more electric coupons redeemed for the user for the transaction. The ecoupon platform may allow or provide for redeeming a cash value of the ecoupon to the transaction prices at the POS system.

Referring now to FIG. 6A, one embodiment of a system for implementing instant reward and performing real time processing based on redemption of a UPC level digital coupon, is depicted. In brief overview, the system includes an ecoupon platform, a monitoring agent 397, and an instore POS system 230. The ecoupon platform may receive transaction information from the POS system via the monitoring agent 397. With the transaction information, the platform may perform any one or more of: (i) redemption processing of an ecoupon, (ii) determine and update instant rewards, (iii) send notification of rewards and/or redemption to a corresponding user, (iv) authorize instant redemption of the coupon toward payment for a transaction, (v) recognize and act on a marketing opportunity to target the user and (vi) generate and provide a digital receipt of the transaction, including showing the rewards or results from redemption of the ecoupon. In some embodiments, the platform may be in further communication with a device 102 operated by a user involved in the transaction. The device 102 may be any type or form of device described above, for example in connection with FIGS. 1A-C.

The POS system may collect, process and/or transmit transaction information, such as UPC level transaction level information. Such transaction information may be processed or transmitted in real time or substantially in real time during a transaction. Embodiments of the transaction information include those described above in connection with FIGS. 2, 3A and 3B. Some portions of the transaction information may be received or intercepted by a monitoring agent 397. The monitoring agent may receive or intercept this information in real time or substantially in real time during a transaction. In some embodiments, the monitoring agent may receive or intercept this information after a transaction is complete.

The monitoring agent 397 may be implemented in hardware or a combination of hardware and software. The monitoring agent 397 may include any script, program, agent or component executing on hardware of the monitoring agent 397 or a host device. In some embodiments, the platform provides or transmits the monitoring agent for installation at a location for intercepting transaction data traffic. The monitoring agent 397 may be designed, built and/or configured to intercept and convey transaction information to the ecoupon platform 120 for processing, for example, in real time as a transaction is taking place. The monitoring agent 397 may be installed or hosted on one or more network devices intermediary between the platform 120 and a POS system. In some embodiments, some portion of the monitoring agent may reside on the POS system, or directly interface with the POS system.

In some embodiments, at least some portion of the monitoring agent resides on an appliance that receives outgoing data originating from a POS system. In certain embodiments, the monitoring agent may include an agent, software or a patch residing or installed on the POS system or a device in communication with the POS system. The monitoring agent may transmit the agent, software or patch to the POS system or the device for installation and/or execution. In some embodiments, the monitoring agent is a passive component that intercepts data transmitted or received by broadcast from one or more POS systems. The monitoring agent may intercept data transmitted or received by broadcast from an intermediary that consolidates or processes data from one or more POS systems. The monitoring agent may reside on a switch, router, network interface, gateway or other device that receives transaction information. The monitoring agent may reside on the same network (e.g., retailer intranet) as a POS system. In some embodiments, the monitoring agent resides in a network receiving the transaction information, for example a network of a credit card or rewards program processing facility. In some embodiments, the monitoring agent is located so as to capture or intercept transaction data as a transaction is being processed. For example, the monitoring agent may be configured and/or located to intercept transaction information transmitted to a credit card or rewards program processing facility. The monitoring agent may operate passively along a transmission path and perform “inline” interception of transaction information. In some other embodiments, the monitoring agent may request for transaction information, e.g., from the POS system.

The monitoring agent may parse, filter, organize or otherwise process the intercepted information. The monitoring agent may remove or ignore extraneous data that the platform may not require or cannot process. The monitoring agent may forward all or some of the intercepted information to the ecoupon platform. In some embodiments, the monitoring agent sends UPC level transaction information to the platform 120. In certain embodiments, the monitoring agent may intercept, extract and/or convey transaction information that involves a UPC level product or service specified in ecoupons provided by the platform. The monitoring agent may intercept, extract and/or convey transaction information involving ecoupon users (e.g., identified as having ecoupon accounts). The monitoring agent may establish and/or maintain a dedicated and/or secure communications tunnel or connection (e.g., SSL VPN connection) with the platform 120. In some embodiments, the monitoring agent may compress and/or encrypt information forwarded to the platform.

The platform 120 may process the information received from the monitoring agent. For example, the platform may parse for transaction information related to an ecoupon and/or an ecoupon user. The platform 120 may validate a transaction against an active ecoupon, for example, using the methods and systems described above. In some embodiments, the platform 120 identifies a redemption of an ecoupon based on the transaction information. The platform may process the transaction information in real time, e.g., while a corresponding transaction is taking place at the POS system. In some embodiments, upon successful validation of a transaction against an ecoupon, the platform may update the ecoupon account of the corresponding user. For example, the platform may deposit a redeemable value specified by the ecoupon into the corresponding ecoupon account. The deposit may be in any form, such as rewards points or cash value, as described above in connection with FIGS. 2, 4A and 4B. In some embodiments, redemption processing in real time or substantially in real time may be referred to as “instant rewarding”.

In some embodiments, the platform may generate and send an electronic or digital receipt (“ereceipt”) to the device of the user. The platform may store the ereceipt on the platform, such in association or in the user's account. The platform may generate for each scanned item intercepted from the POS system a corresponding line item in the ereceipt. The platform may generate lines items in the ereceipt in real-time as each scanned item is received by the platform. A user at the POS system may view the building of the ereceipt on the user's device. In some embodiments, the platform may generate line items in the ereceipt in batch mode or predetermined frequency, such as every X items scanned or every X seconds into the transaction. In some embodiments, the platform may generate the ereceipt upon completion of the transaction. The platform may email the ereceipt to a user's email account and/or post the ereceipt to the user's platform account.

The line items in the ereceipt may include all or a portion of the information received via the scanner at the POS system. The ereceipt may be a replica or facsimile of the paper receipt provided by or at the POS system. In some embodiments, the platform may augment the scanned information received from the POS with additional information about the scanned item. The platform may include any user profile or account information from the platform in the ereceipt. The ereceipt may show the redemption value, credit or reward from redemption of the ecoupon for the transaction. In some embodiments, the ereceipt shows all the items purchased at the POS system for the transaction. In some embodiments, the ereceipt shows all the items purchased at the POS system for the transaction plus the redemption of any non-ecoupons In some embodiments, the ereceipt shows the all the items purchased at the POS system for the transaction, with or without non-ecoupons, with an indication, description or a line item for the ecoupon redemption. While the paper based receipt at the POS system shows all the scanned items and any redeemed paper coupons or store loyalty discounts or coupons, the paper based receipt will not show the redemption of the ecoupon. The ereceipt shows the redemption of the ecoupon as applied to the transaction at the POS system, such as for partial payment. The ereceipt may show a history of ecoupon redemptions for a certain time frame, such as year-to-date.

In some embodiments, the platform may send an update to the user regarding the redemption. The platform may send a notification of the redemption status and/or the deposit to a device of the user, such as via any type and form of message (email, text, mobile app, etc.) to a smartphone, laptop or tablet device of the user. The update or notification may be sent in real time or upon completion of the transaction. In some embodiments, the update is sent responsive to a successful redemption. The update or notification may be sent according to a schedule, e.g., as a daily or weekly update. The update or notification may be sent via any transmission mode, such as email, instant messaging, text message, Twitter “tweet”, via social media, via an update to a social networking site, via an ecoupon app executing on a user device, voice message, and so on. The notification may indicate or include any of: a redeemed value, redemption date and time, transaction information (e.g., store and purchased product), accrued redemptions, ecoupon usage statistics, and ecoupons previously selected and currently available to the user.

In some embodiments, the platform accesses the user's profile and/or personalized information from the platform database 250. In some embodiments, the platform may receive additional information from an ecoupon app executing on the user's mobile device, such as proximity of the user to a store, or the user's recent search history for ecoupons or products. The platform may identify or recognize a marketing opportunity based on the additional information, the transaction information, the user's profile and/or the user's personalized information. For example, the ecoupon manager 220 and/or the IA engine 219 may identify an ecoupon campaign based on any one or a combination of these information. The platform may identify an ecoupon campaign featuring a product related to the purchase transaction, or available in the store. In some embodiments, the platform is in communication with an ad server or ad exchange to identify an ad campaign based on any one or a combination of these information. For example, the ad server may identify an ad sponsored by the store where the transaction is taking place. Based on the identification, the platform may include an ecoupon and/or ad in a message directed to the user. The platform may send the message in real time during the transaction. The message may be sent in any form, combined or separate from the status update discussed above. In some embodiments, the message includes an ad that provides a link to select or download an ecoupon. Accordingly, using the present systems and methods, the ecoupon platform may implement personalized and/or context-specific marketing targeted at the user.

In some embodiments, the platform may deliver the ecoupon or ad to the ecoupon user's account or ecoupon app. The platform may schedule delivery of the ecoupon or ad based on a campaign strategy. In some embodiments, the platform may communicate with a rewards program administrator or other third party (e.g., Catalina) to execute a tie-in promotion or to issue rewards. For example, upon receiving or sharing information from the platform, the third party may communicate with the POS system to generate a printout of a coupon, ad, voucher or user survey. For example, the printout may accompany or reside on a receipt for the transaction. In some instances, based at least in part of the information from the platform, the third party may process certain rewards for the user in real time, or may prompt the user to sign up for a new rewards program or credit card.

In some embodiments, the platform may identify and act on certain aspects of the transaction, e.g., in real time. For example, the platform may recognize that a product scanned at the POS system does not exactly match an ecoupon that the user has. The platform may detect coupon stacking, e.g., of paper and electronic coupons, which the sponsor may not allow. The platform may detect that an ecoupon for a transaction item has expired and cannot be redeemed, and/or may offer an alternative ecoupon for immediate use. The platform may detect that an alternative ecoupon may provide more savings based on the quantity of a featured item purchased. Based on such occurrences, the platform may send an alert or message to the user as the transaction is occurring. In some cases, an alternative ecoupon may be applied during the transaction or after the transaction is completed. Thus, the ecoupon platform can not only help a user manage ecoupon-related purchases, but may also promote the use of ecoupons.

In some embodiments, the platform processes an ecoupon redemption in real time, e.g., during a transaction. The platform may authorize a payout to the retailer towards the purchase price of a product based on the real time processing. In some embodiments, the platform may instruct the POS system or retailer to subtract the redeemable value from the total purchase price payable by the user. The platform may make any type or form of arrangement with a retailer to reimburse the retailer with the subtracted value. For example, in some embodiments, the platform and/or campaign sponsor maintains an account to track or issue payments to a retailer based on ecoupon redemptions. In some embodiments, the user uses a device of the user to make payment based on the ecoupon at the POS system, such as scanning in the electronic coupon via the POS scanner or using near field communications to communicate the payment to the POS system. In some embodiments, the platform facilitates payment via a mobile device of the user or the user's store rewards card or a credit or debit card of the user. In some embodiments, the platform provides the user with a credit card, bank or other account number from which the cash value of ecoupons or other rewards can be applied to the transaction.

Illustrated in FIG. 6B is an embodiment of a method for implementing instant reward and performing real time processing based on redemption of a UPC level digital coupon. In one embodiment, a monitoring agent collects transaction data associated with a redemption of an electronic coupon by a user in an instore transaction (Step 650). An electronic coupon platform in communication with the monitoring agent may determine an amount redeemable by the user during the instore transaction (Step 655). The ecoupon platform may update an account of the user based on the status of the redemption (Step 660). The ecoupon platform may send a status of the redemption to the user (Step 665). The ecoupon platform may authorize the instore transaction to apply the amount redeemable towards payment due from the user (Step 670).

Referring to step 650, and in some embodiments, a monitoring agent collects transaction data associated with a redemption of an electronic coupon by a user in an instore transaction. The monitoring agent may perform inline interception of transaction data originating from one or more POS systems. The monitoring agent may perform real time or substantially real time interception of transaction data as they are generated from one or more POS systems. The monitoring agent may intercept, receive or capture transaction data while an instore transaction is taking place. In some embodiments, the monitoring agent intercepts or captures transaction data from an intermediary that consolidates or processes data from one or more POS systems. The monitoring agent may intercept outgoing transaction data directed to a credit card or rewards program processing facility.

The monitoring agent may parse, filter, organize or otherwise process the intercepted information. The monitoring agent may remove or ignore extraneous data that the platform may not require or cannot process. The monitoring agent may forward all or some of the intercepted information to the ecoupon platform 120. In some embodiments, the monitoring agent sends UPC level transaction information to the platform 120. In certain embodiments, the monitoring agent may intercept, extract and/or convey transaction information involving a UPC level product or service featured in current ecoupons provided by the platform. The monitoring agent may intercept, extract and/or convey transaction information involving ecoupon users (e.g., identified as having ecoupon accounts). The monitoring agent may establish and/or maintain a dedicated and/or secure communications tunnel or connection (e.g., SSL VPN connection) with the platform 120. In some embodiments, the monitoring agent may compress and/or encrypt information forwarded to the platform.

The ecoupon platform may receive transaction information, real-time or otherwise, from POS systems via the monitoring agent. The ecoupon platform may receive transaction information real-time or otherwise, from POS systems via any type and form of intermediary devices, such as a store server or a monitoring hub or an aggregating device for the monitoring agents. The ecoupon platform may receive transaction information intercepted from the POS system by a monitoring agent, which transmits the transaction information via the one or more networks to a server of the platform. The ecoupon platform receives transaction information identifying Universal Product Code (UPC) level information about a product or service being purchased by a user via a transaction at the POS system.

In further details of step 655, an electronic coupon platform in communication with the monitoring agent may determine an amount redeemable by the user during the instore transaction. The platform 120 may process the information received from the monitoring agent, for example, parse for transaction information related to an ecoupon and/or ecoupon user. Upon identifying a related ecoupon, the platform 120 may validate the transaction against the ecoupon. The platform may validate the transaction information against one or more electronic coupons of the user stored in an account managed by the platform. For example, the platform may verify if the conditions specified by the ecoupon (e.g., validity period, matching UPC item) are met based on the transaction information. Upon validation, the platform may determine the amount redeemable, as specified by the ecoupon. The platform may validate the redemption in real time while the corresponding transaction is taking place at the POS system. The platform may redeem one or more electronic coupons of the user via an account managed by the platform for tracking the one or more electronic coupons of the user. The platform may prior to completion of the transaction determine an amount redeemable by the user for payment towards the transaction. The platform may generate an ereceipt for the transaction during the transaction. The platform may transmit prior to completion of the transaction at the POS system, an electronic receipt to the device of the user.

Referring to step 660, and in some embodiments, the ecoupon platform may update an account of the user based on the status of the redemption. In some embodiments, upon successful validation of a transaction against an ecoupon, the platform may update the ecoupon account of the corresponding user. The platform may deposit the redemption value specified by the ecoupon into the ecoupon account. The deposit may be in any form, such as rewards points or cash value, as described above in connection with FIGS. 2, 4A and 4B. The platform may update the total value redeemed by the user in the account. The platform may update a status of the redeemed coupon, e.g., to inactive or redeemed. The platform may update the ereceipt to reflect the status of the redeemed coupon.

In further details of step 665, the ecoupon platform may send, to the user, a status of the redemption by the user. In some embodiments, the platform may send an updated receipt to user regarding the redemption status and/or transaction details. In some embodiments, the platform may send an update to the user regarding the redemption status. The platform may send a notification of the redemption status and/or the deposit to a device of the user, such as a smartphone, laptop or tablet device. The update or notification may be sent in real time or upon completion of the transaction. In some embodiments, the update is sent responsive to a successful redemption. The update or notification may be sent according to a schedule, which may be user-configurable. The update or notification may be sent via any transmission method, such as email, instant messaging, text message, Twitter “tweet”, via a social media, via an ecoupon app, voice message, and so on.

In some embodiments, the ecoupon platform may implement personalized and/or context-specific marketing targeted at the user. The platform may access the user's profile and/or personalized information from the platform database 250. The platform may receive additional information from an ecoupon app executing on the user's mobile device, e.g., present location of the user. The platform may identify or recognize a marketing opportunity based on the additional information, the transaction information, the user's profile and/or the user's personalized information. By way of illustration, the ecoupon manager 220 and/or the IA engine 219 may identify an ecoupon campaign based on any one or a combination of these information. In some embodiments, the platform is in communication with an ad server or ad exchange to identify an ad campaign based on any one or a combination of these information. Based on the identification, the platform may deliver an ecoupon and/or ad in a message to the user. The platform may send the message in real time during the transaction.

In some embodiments, the platform may deliver the ecoupon or ad to the ecoupon user's account or ecoupon app. The platform may schedule delivery of the ecoupon or ad based on a campaign strategy. In some embodiments, the platform may communicate with a rewards program administrator or other third party to execute a tie-in promotion or process rewards for the user. In one embodiment, upon receiving information from the platform, the third party may communicate with the POS system to generate a printout of a coupon, ad, voucher or survey for the user. In some embodiments, based on the information from the platform, the third party may process loyalty points or rewards for the user in real time. The third party may also prompt the user to sign up for a new rewards program or a credit card.

Referring to step 670, and in some embodiments, the ecoupon platform may authorize the instore transaction to apply the amount redeemable towards payment due from the user. The platform may process an ecoupon redemption in real time, e.g., while a transaction is taking place. The platform may authorize a payout to the retailer towards the purchase price of a product based on the instant or real time redemption. The platform may authorize applying a cash value of a redeemed electronic coupon to a purchase of the transaction as partial payment. The platform may communicate with the POS system or other systems in communication with the POS system to apply the cash value towards the purchase price for the transaction. In some embodiments, the platform may instruct the POS system or retailer to subtract the redeemable value from the total purchase price payable by the user. The platform may for example reimburse the retailer with the subtracted value after the transaction. In some embodiments, the platform and/or campaign sponsor maintains an account to track or issue payments to a retailer based on ecoupon redemptions. Although instore transactions were sometimes discussed above, these are merely illustrative in nature and not intended to be limiting in any way. For example, transaction information from online POS systems, or related to any other medium (e.g., automated phone transactions), may be intercepted by a monitoring agent. Real time processing with respect to online transactions for example, may be similarly performed. In some embodiments, the platform uses or facilitates any type and form of mobile payment system for the user to use a mobile device or smartphone to apply value/cash/credit from the redemption of one or more ecoupons to payment for the transaction. The platform may generate and/or transmit an ereceipt to a device of the user showing the application of payment for the transaction corresponding to the value from the ecoupon.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of the methods and systems above, it will now become apparent to one of skill in the art that other embodiments incorporating the concepts of the disclosure may be used.

What is claimed:

1. A method for personalized electronic coupon targeting based on offline Universal Product Code (UPC) tracking, the method comprising:
(a) receiving, by a server via one or more networks from one or more point of sale (POS) systems, Universal Product Code (UPC) transaction information attributable to a specific user making offline transactions at one or more stores associated with the one or more POS systems;
(b) analyzing, by the server, behavior of the specific user at a UPC level based on the UPC transaction information;
(c) updating, by the server, a user profile of the specific user based on the analysis;
(d) identifying, by the server, the specific user interacting with an online medium; and
(e) determining, by the server based on the user profile, an electronic coupon campaign to be delivered via the online medium to the specific user.

2. The method of claim 1, wherein step (a) further comprises receiving, by the server, UPC transaction information from the specific user making offline transactions at physical locations of the one or more stores via the one or more POS systems.

3. The method of claim 1, wherein step (b) further comprises analyzing, by the server, behavior of the specific user at the UPC level to identify purchases of related goods or servers in transactions of the specific user.

4. The method of claim 1, wherein step (b) further comprises analyzing, by the server, behavior of the specific user at the UPC level to identify quantity of items purchased in the transaction of the specific user.

5. The method of claim 1, wherein step (b) further comprises analyzing, by the server, behavior of the specific user at the UPC level to identify one of time or frequency of visits to the one or more stores corresponding to the transactions of the specific user.

6. The method of claim 1, wherein step (b) further comprises analyzing, by the server, behavior of the specific user at the UPC level to identify items purchased in the connection with a promotion.

7. The method of claim 1, wherein step (c) further comprises updating, by the server, the user profile to identify the specific user's preferences based on the analysis.

8. The method of claim 1, wherein step (d) further comprises receiving, by the server, identification of the specific user from an online service provider, the online service provider providing the online medium via which the user is interacting.

9. The method of claim 1, wherein step (d) further comprises identifying, by the server, the specific user via a cookie.

10. The method of claim 1, wherein step (e) further comprises delivering, by the server, an electronic coupon to the specific user via the online medium.

11. A system for personalized electronic coupon targeting based on offline Universal Product Code (UPC) tracking, the system comprising:
a server receiving, via one or more networks from one or more point of sale (POS) systems, Universal Product Code (UPC) transaction information attributable to a specific user making offline transactions at one or more stores associated with the one or more POS systems;
an electronic coupon manager of the server analyzing behavior of the specific user at a UPC level based on the UPC transaction information and updating a user profile of the specific user based on the analysis; and
wherein the server, responsive to identifying the specific user interacting with an online medium, determines, based on the user profile, an electronic coupon campaign to be delivered via the online medium to the specific user.

12. The system of claim 11, wherein the server receives UPC transaction information from the specific user making offline transactions at physical locations of the one or more stores via the one or more POS systems.

13. The system of claim 11, wherein the electronic coupon manager analyzes behavior of the specific user at the UPC level to identify purchases of related goods or servers in transactions of the specific user.

14. The system of claim 11, wherein the electronic coupon manager analyzes behavior of the specific user at the UPC level to identify quantity of items purchased in the transaction of the specific user.

15. The system of claim 11, wherein the electronic coupon manager analyzes behavior of the specific user at the UPC level to identify one of time or frequency of visits to the one or more stores corresponding to the transactions of the specific user.

16. The system of claim 11, wherein the electronic coupon manager analyzes behavior of the specific user at the UPC level to identify items purchased in the connection with a promotion.

17. The system of claim 11, wherein the electronic coupon manager updates the user profile to identify the specific user's preferences based on the analysis.

18. The system of claim 11, wherein the server received identification of the specific user from an online service provider, the online service provider providing the online medium via which the user is interacting.

19. The system of claim 11, wherein the server identifies the specific user via a cookie.

20. The system of claim 11, wherein the server delivers an electronic coupon to the specific user via the online medium.
